(19) United States
(12) Patent Application Publication
(10) Pub. No.: US 2018/0018611 A1
(43) Pub. Date: Jan. 18, 2018

(54) RISK DETERMINATION DEVICE, RISK DETERMINATION METHOD, AND RISK DETERMINATION PROGRAM

(71) Applicant: Konica Minolta, Inc., Tokyo (JP)

(72) Inventor: Kouichi TOMITA, Kawanishi-shi (JP)

(21) Appl. No.: 15/615,394

(22) Filed: Jun. 6, 2017

(30) Foreign Application Priority Data
Jul. 15, 2016 (JP) 2016-140091

(51) Int. Cl. G06Q 10/06; H04L 12/58

(52) U.S. Cl. CPC G06Q 10/063114; G06Q 10/0635; H04L 51/02

(57) ABSTRACT

A risk determination system includes: an intergroup relationship decision unit configured to decide a first relationship indicating a relative relation between a first group and a second group; an interperson relationship decision unit configured to decide a second relationship indicating a degree of connection of a person belonging to the first group to the second group; and a determination unit configured to determine a risk in the first group to the second group on the basis of the first relationship and the second relationship.

The entire disclosure of Japanese Patent Application No. 2016-140091 filed on Jul. 15, 2016 including description, claims, drawings, and abstract are incorporated herein by reference in its entirety.

### BACKGROUND OF THE INVENTION

### Field of the Invention

The present invention relates to a risk determination device, a risk determination method, and a risk determination program, and especially relates to a risk determination device that determines a risk between companies, and a risk determination method and a risk determination program executed in the risk determination device.

### Description of the Related Art

Relation between persons is an important element for companies to maintain activities. Especially, in business, maintaining relations with customers is important. As a technology to visualize human relations, JP 2009-9355 A describes an organization communication visualization system that is a sensor network system including a plurality of terminals and a processing device that processes data transmitted from the plurality of terminals, wherein each of the terminals includes a sensor that detects a physical amount and a data transmission unit that transmits data that indicates the physical amount detected by the sensor, and the processing device performs plotting, on the basis of data transmitted from a first terminal, on a coordinate plane having, as two axes, strength of a relation with another person, and diversity of the relation, of a first person equipped with the first terminal.

However, there is a problem that a relation between companies to which a plurality of humans belongs cannot be visualized only from the human relations of the plurality of humans.

### SUMMARY OF THE INVENTION

The present invention has been made to solve the above problems, and one of objects of the present invention is to provide a risk determination system that enables determination of a risk between groups from an activity of a person belonging to the group.

Another object of the present invention is to provide a risk determination method that enables determination of a risk between groups from an activity of a person belonging to the group.

Still another object of the present invention is to provide a risk determination program that enables determination of a risk between groups from an activity of a person belonging to the group.

To achieve at least one of the abovementioned objects, according to an aspect, a risk determination system reflecting one aspect of the present invention comprises: an intergroup relationship decision unit configured to decide a first relationship indicating a relative relation between a first group and a second group; an interperson relationship decision unit configured to decide a second relationship indicating a degree of connection of a person belonging to the first group to the second group; and a determination unit configured to determine a risk in the first group to the second group on the basis of the first relationship and the second relationship.

According to this aspect, the risk in the first group to the second group is determined on the basis of the relative relation between the first group and the second group, and the degree of connection of the person belonging to the first group to the second group. Therefore, a risk determination system that enables determination of a risk between groups from an activity of a person belonging to the group can be provided.

The determination unit preferably compares the second relationship with a reference decided on the basis of the first relationship.

According to this aspect, the degrees of connection of the individual persons belonging to the first group with the second group are compared with the references decided by the relative relations between the first group and the second group. Therefore, the risks can be determined by the references suitable for two groups serving as targets of the risk determination. As a result, two groups serving as the targets of the risk determination are not limited.

The intergroup relationship decision unit preferably decides the first relationship on the basis of relative relations between the second group and one or more respective groups other than the second group, of a plurality of groups including the second group.

According to this aspect, the first relationship is decided on the basis of the relative relations between the plurality of respective groups related to the first group and the second group. Therefore, the first relationship suitable for the plurality of groups related to the first group.

The determination unit preferably determines the risk on the basis of temporal change of the second relationship.

According to this aspect, the temporal change of the degree of connection of the person belonging to the first group to the second group is determined. Therefore, the risk can be predicted from a tendency of the degree of connection.

When there is a plurality of the persons belonging to the first group, the determination unit preferably determines the risk on the basis of deviation of the second relationships respectively corresponding to the plurality of persons.

According to this aspect, the risk is determined by the deviation of the degrees of connection of the plurality of persons belonging to the first group to the second group. Therefore, concentration of the degrees of connection of the persons can be determined as the risk.

When there is a plurality of the persons belonging to the first group, the determination unit preferably determines the risks of the plurality of the persons to the second group on the basis of the first relationship and the second relationships respectively corresponding to the plurality of persons.

According to this aspect, a risk to the second group is determined for each of a plurality of persons belonging to the first group. Therefore, the risk can be determined for each person.

To achieve at least one of the abovementioned objects, according to an aspect, a risk determination method reflecting one aspect of the present invention comprises the steps of: deciding a first relationship indicating a relative relation between a first group and a second group; deciding a second relationship indicating a degree of connection of a person who belongs the first group to the second group; and determining a risk in the first group to the second group on the basis of the first relationship and the second relationship.

According to this aspect, a risk determination method that enables determination of a risk between groups from an activity of a person belonging to the group can be provided.

To achieve at least one of the abovementioned objects, according to an aspect, a non-transitory recording medium storing a computer readable risk determination program reflecting one aspect of the present invention causes a computer to execute the steps of: deciding a first relationship indicating a relative relation between a first group and a second group; deciding a second relationship indicating a degree of connection of a person who belongs the first group to the second group; and determining a risk in the first group to the second group on the basis of the first relationship and the second relationship.

According to this aspect, a risk determination program that enables determination of a risk between groups from an activity of a person belonging to the group can be provided.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a diagram illustrating an example of an overview of a risk determination system in the present embodiment;

FIG. 2 is a diagram illustrating an example of a hardware configuration of a risk determination device;

FIG. 3 is a block diagram illustrating an example of functions held by a CPU included in the risk determination device;

FIG. 4 is a diagram illustrating an example of a format of customer company information;

FIG. 5 is a diagram illustrating an example of a format of company transaction information;

FIG. 6 is a diagram illustrating an example of a format of personal transaction information;

FIG. 7 is a flowchart illustrating an example of a flow of risk determination processing;

FIG. 8 is a flowchart illustrating an example of a flow of first relationship decision processing;

FIG. 9 is a flowchart illustrating an example of a flow of transaction item score decision processing;

FIG. 10 is a flowchart illustrating an example of a flow of second relationship decision processing;

FIG. 11 is a flowchart illustrating an example of a flow of comparison processing;

FIG. 12 is a flowchart illustrating an example of number of individual connected persons comparison processing;

FIG. 13 is a flowchart illustrating an example of a flow of number of company connected persons comparison processing;

FIG. 14 is a flowchart illustrating an example of a flow of individual connection strength comparison processing;

FIG. 15 is a flowchart illustrating an example of a flow of company connection strength comparison processing;

FIG. 16 is a flowchart illustrating an example of a flow of number of connected persons decreasing rate comparison processing;

FIG. 17 is a flowchart illustrating an example of a flow of number of persons decrease period comparison processing;

FIG. 18 is a flowchart illustrating an example of a flow of connection strength decreasing rate comparison processing;

FIG. 19 is a flowchart illustrating an example of a flow of strength decrease period comparison processing;

FIG. 20 is a flowchart illustrating an example of a flow of number of connected persons deviation comparison processing;

FIG. 21 is a flowchart illustrating an example of a flow of connection strength deviation comparison processing;

FIG. 22 is a diagram illustrating an example of a table for deciding a score for a transaction value;

FIG. 23 is a diagram illustrating an example of a table for deciding a factor for existence or non-existence of a core product;

FIG. 24 is a diagram illustrating an example of company transaction information;

FIG. 25 is a diagram illustrating an example of a table for deciding a score for the number of employees;

FIG. 26 is a diagram illustrating an example of a table for deciding a score for ordinary income and loss;

FIG. 27 is a diagram illustrating an example of a table for deciding a score for a treasury stock percentage;

FIG. 28 is a diagram illustrating an example of a table for deciding a factor for friendliness;

FIG. 29 is a diagram illustrating an example of customer company information;

FIG. 30 is a diagram illustrating a score, a factor, and company importance of a plurality of items of the customer companies;

FIG. 31 is a diagram illustrating an example of a table for deciding a score for a position;

FIG. 32 is a diagram illustrating an example of a table for deciding a score for contact means; and

FIG. 33 is a diagram illustrating an example of a table for deciding a factor for contact content.

### DESCRIPTION OF THE PREFERRED EMBODIMENTS

Hereinafter, an embodiment of the present invention will be described with reference to the drawings. However, the scope of the invention is not limited to the illustrated examples. In the description below, the same components are denoted with the same reference sign. Names and functions of the same components are the same. Therefore, detailed description of the same components is not repeated.

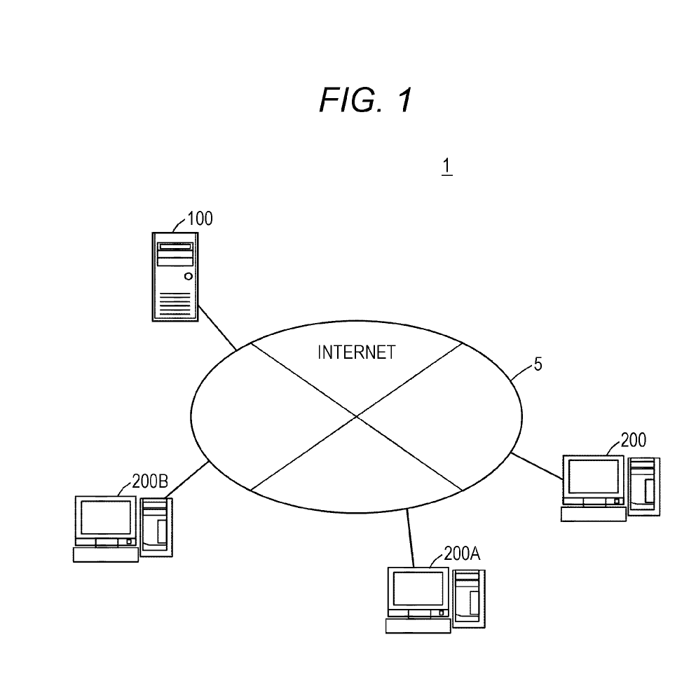

FIG. 1 is a diagram illustrating an example of an overview of a risk determination system in the present embodiment. Referring to FIG. 1, a risk determination system 1 includes a risk determination device 100, and personal computers (hereinafter “PCs”) 200, 200A, and 200B.

The respective PCs 200, 200A, and 200B are used by users who receive a risk determination service from the risk determination device 100. The PCs 200, 200A, and 200B are typical computers, and respective hardware configurations and functions are the same. Therefore, here, the PC 200 will be described as an example unless specifically mentioned. The risk determination device 100 is a typical computer, and a server device or the like can be used. The risk determination device 100 provides the risk determination service for a user such as a pharmacist who operates the PC 200, 200A, or 200B.

The risk determination device 100 and PCs 200, 200A, and 200B are connected to the internet 5. The risk determination device 100 functions as a server, and the PCs 200, 200A, and 200B function as clients. In the present embodiment, an example of causing the risk determination device 100 to function as a web server, and installing a browsing program to the PCs 200, 200A, and 200B will be described. The PCs 200, 200A, and 200B function as the clients of the risk determination device 100 by executing the browsing program. A typically common browsing program may just be installed to the PCs 200, 200A, and 200B, and thus a risk determination system can be easily constructed.

In the present embodiment, operations as the clients of the PCs 200, 200A, and 200B are the same, and thus a case in which the user operates the PC 200 and receives the risk determination service provided by the risk determination device 100 will be described as an example in the description below. In this case, for example, the risk determination device 100 releases a URL of a home page, which is decided in advance to provide the risk determination service, to receive accesses from outside. When the user who operates the PC 200 executes the browsing program and inputs the URL of the home page, the PC 200 transmits, to the risk determination device 100, a command that requests the risk determination device 100 to transmit the home page. The risk determination device 100 returns the home page stored an HDD 104 in advance to the PC 200 that has transmitted the command, upon receipt of the command that requests transmission of the home page. The PC 200 that receives the home page displays the home page, and the user can receive the risk determination service provided by the risk determination device 100.

Note that the risk determination device 100 may provide the risk determination service only to a user decided in advance. In this case, the risk determination device 100 may just provide the risk determination service on condition of success of the user of the PC 200 to login authentication. For example, a user ID and a password of the user who will receive the risk determination service are registered in the risk determination device 100 in advance, and a login screen having an area in which the user ID and the password can be input is transmitted to the PC 200. When the user of the PC 200, who receives the login screen, inputs the user ID and the password, the PC 200 transmits, to the risk determination device 100, the login request including the user ID and the password input by the user. The risk determination device 100 provides the risk determination service on condition of registration of the user ID and the password included in the login request, upon receipt of the login request from the PC 200. With this process, the user provided with the risk determination service can be limited to the user decided in advance. Further, the risk determination service can be paid by the user decided in advance.

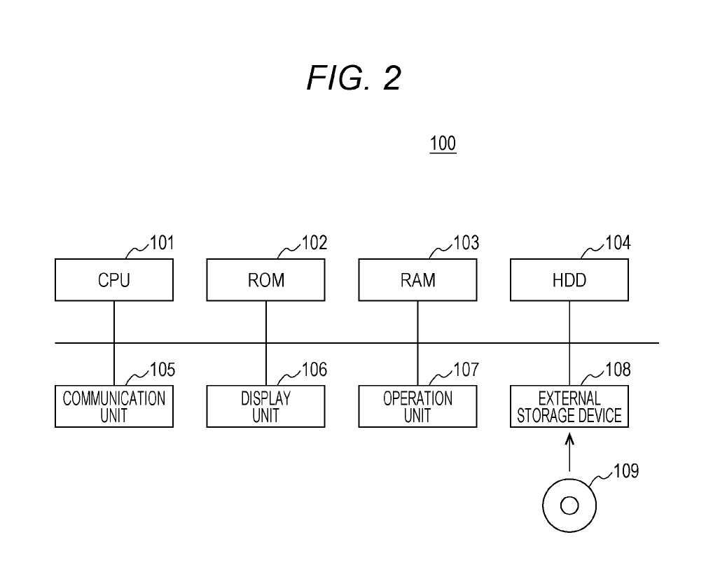

FIG. 2 is a diagram illustrating an example of a hardware configuration of the risk determination device. Referring to FIG. 2, the risk determination device 100 includes a central processing unit (CPU) 101 of controlling the entire risk determination device 100, a read only memory (ROM) 102 that stores a program for being executed by the CPU 101, a random access memory (RAM) 103 used as a work area of the CPU 101, a hard disk drive (HDD) 104 that stores data in a non-volatile manner, a communication unit 105 that connects the CPU 101 to the internet 5, a display unit 106 that displays information, an operation unit 107 that receives an input of an operation of the user, and an external storage device 108.

The CPU 101 loads the program stored in the ROM 102 or the HDD 104 to the RAM 103 and executes the program. A compact disk ROM (CD-ROM) 109 that stores a program is mountable to the external storage device 108. The CPU 101 can access the CD-ROM 109 through the external storage device 108. The CPU 101 can load the program recorded on the CD-ROM 109 to the RAM 103 and can execute the program.

As the program executed by the CPU 101, the program recorded in the ROM 102, the HDD 104, or the CD-ROM 109 has been described. However, a program rewritten from the program stored in the HDD 104 or an added and written new program by another computer connected to the internet 5 may be used. A program downloaded by the risk determination device 100 from another computer connected to the internet 5 may be used. The program referred here includes not only a program directly executable by the CPU 101 but also a source program, a compressed program, and an encrypted program.

As a medium that stores the program executed by the CPU 101, not only the CD-ROM 109 but also an optical disk (magnetic optical disc (MO))/mini disc (MD)/digital versatile disc (DVD)), or a semiconductor memory such as an IC card, an optical card, a mask ROM, an erasable programmable ROM (EPROM), or an electrically erasable programmable ROM (EEPROM) may be used.

In the present embodiment, in a state in which a target company performs business activities with a plurality of customer companies, the risk determination device 100 determines a risk of the target company to the plurality of customer companies. In the description below, a case in which a company A to which the user who operates the PC 200 belongs is the target company, and two companies B1 and B2 with which the target company A transacts business are the customer companies will be described as an example.

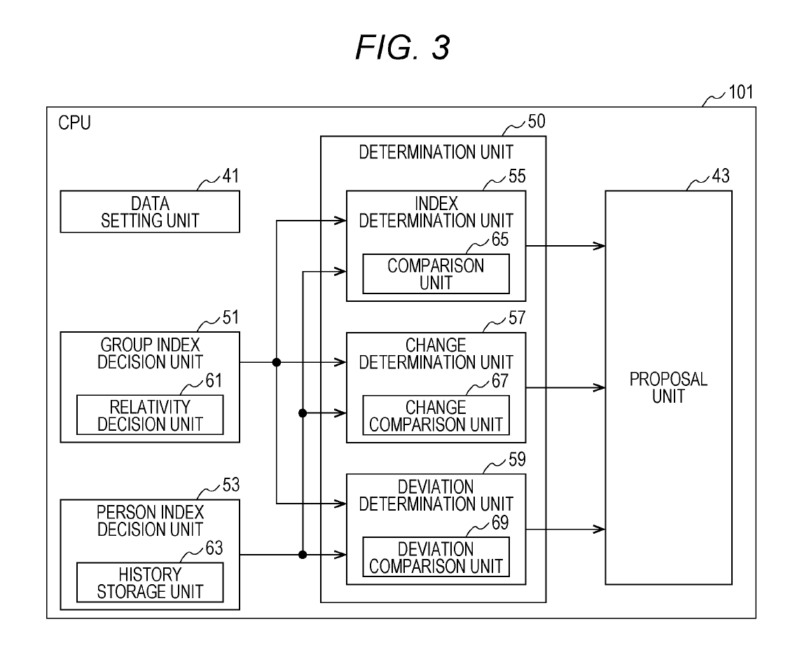

FIG. 3 is a block diagram illustrating an example of functions held by the CPU included in the risk determination device. The functions illustrated in FIG. 3 are formed in the CPU 101 when the CPU 101 included in the risk determination device 100 executes a risk determination program stored in the ROM 102, the HDD 104, or the CD-ROM 109. Referring to FIG. 3, the CPU 101 included in the risk determination device 100 includes a data setting unit 41, a group index decision unit 51, a person index decision unit 53, a determination unit 50, and a proposal unit 43.

The data setting unit 41 stores customer company information and transaction information to the HDD 104. The customer company information is stored for each target company. The customer company information includes basic information and company connection information. The basic information is information that indicates the scale of the customer company. The company connection information is information that indicates connection between the target company and the customer company. The transaction information includes company transaction information and personal transaction information. The company transaction information is a history of transactions of the target company for each customer company. The personal transaction information is a history of contact of a person belonging to the target company, with persons belonging to the customer company.

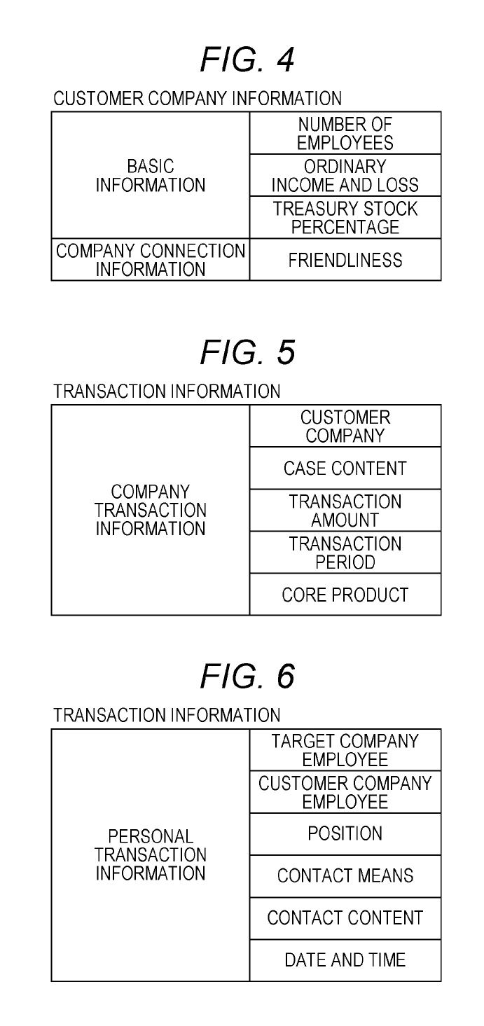

FIG. 4 is a diagram illustrating an example of a format of the customer company information. Referring to FIG. 4, the customer company information includes the basic information and the company connection information. The basic information includes the number of employees, ordinary income and loss, and a treasury stock percentage. The treasury stock percentage is a ratio of stocks held by the customer company to issued stocks of the customer company. The unit is percent. The company connection information includes friendliness that indicates a relation with the customer company. The friendliness indicates a relation with the customer company as viewed from the target company. The friendliness includes any of existence or non-existence of a cooperative relation, whether the customer company is an associated company such as a subsidiary or a parent company, whether the customer company is in a competitive relation, existence or non-existence of a dispute regarding a legal matter, or the customer company is in a neutral state without any interest.

FIG. 5 is a diagram illustrating an example of a format of the company transaction information. Referring to FIG. 5, the company transaction information includes company identification information, case content, a transaction amount, a transaction period, and whether a product is a core product, of the customer company. The case content includes a product name and a quantity of a transacted case.

FIG. 6 is a diagram illustrating an example of a format of the personal transaction information. Referring to FIG. 6, the personal transaction information includes person identification information of an employee belonging to the target company, person identification information of an employee belonging to the customer company, a position of the person belonging to the customer company, contact means, contact content, and date and time. The person identification information includes company identification information for identifying the company to which the person belongs and personal identification information for identifying the person. The contact means is means of contact, and here includes an electronic mail, a telephone, and an interview. The contact content is a purpose of contact, and includes greeting, negotiation, an answer to a customer, a contract, and complaint reception.

Referring back to FIG. 3, the group index decision unit 51 decides a first relationship on the basis of the customer company information and the company transaction information stored in the HDD 104. The first relationship indicates a relative relation between the target company as a first group and the customer company as a second group. Typically, there is a plurality of the customer companies. The group index decision unit 51 includes a relativity decision unit 61. Here, a case in which the customer companies B1 and B2 exist for the target company A will be described as an example. In this case, the relativity decision unit 61 decides a relative relation between the customer companies B1 and B2 on the basis of relative relationships between the target company A and the respective customer companies B1 and B2. Further, the relativity decision unit 61 decides the first relationship on the basis of the relative relation between the customer companies B1 and B2. The group index decision unit 51 outputs the first relationship of the target company A respectively decided with the customer companies B1 and B2 to the determination unit 50.

To be specific, when the group index decision unit 51 decides the first relationship of the target company A with the customer company B1, the group index decision unit 51 outputs a set of the company identification information of the target company A, the company identification information of the customer company B1, and the first relationship decided with the customer company B1 to the determination unit 50 as first relation information. When the group index decision unit 51 decides the first relationship of the target company A with the customer company B2, the group index decision unit 51 outputs a set of the company identification information of the target company A, the company identification information of the customer company B2, and the first relationship decided with the customer company B2 to the determination unit 50 as first relation information.

To be more specific, the group index decision unit 51 decides the first relationship for each of the customer companies B1 and B2, using the customer company information and the company transaction information stored in the HDD 104 for the target company A. The company transaction information is stored in the HDD 104 for each customer company and for each transaction case, and includes an item of the transaction amount and an item of the core product. The group index decision unit 51 scores a value of the item of the transaction amount with a reference decided in advance to adjust the unit among the plurality of items, weights the scored score with a predetermined weighting factor in a case of the core product, and employs, for each customer company, a total of the scores of a plurality of transaction cases as a transaction item score of the customer company. The transaction item scores indicate the relative relations in the transactions between the target company A and the respective customer companies B1 and B2.

Further, the group index decision unit 51 scores values of the plurality of items decided in the customer company information with the reference decided in advance to adjust the unit among the plurality of items. The customer company information includes fixed items and a relation item. The fixed items are the number of employees, the ordinary income and loss, and the treasury stock percentage included in the basic information, and the relation item is the friendliness included in the company connection information. The group index decision unit 51 decides, for the respective customer companies B1 and B2, respective company importances of the customer companies B1 and B2 on the basis of the transaction item score, the score decided for each of the plurality of fixed items, and the score of the relation item. The company importance is a value obtained by multiplying a sum of the transaction item score and the score decided for each of the plurality of fixed items, by the score of the relation item. The company importances indicate overall relative relations between the target company A and the relative customer companies B1 and B2. The group index decision unit 51 decides the respective first relationships with the customer companies B1 and B2 on the basis of the company importance of the customer company B1 and the company importance of the customer company B2. To be specific, a value obtained by dividing the company importance of the customer company B1 by an average of the company importances is decided to be the first relationship with the customer company B1, and a value obtained by dividing the company importance of the customer company B2 by an average of the company importances is decided to be the first relationship with the customer company B2. Therefore, the first relationships with the respective customer companies B1 and B2 are values that indicate the relative relations of the company importances of the respective customer companies B1 and B2.

Note that relative values may be used in place of using the scores. For example, the group index decision unit 51 may use relative values obtained by converting the transaction item scores of the respective two customer companies B1 and B2 into values that indicate a relative relation between the customer companies B1 and B2. To be specific, an average of the scores is calculated, and values obtained by subtracting the average score from the scores of the respective customer companies B1 and B2 are decided to be the relative values. Alternatively, the group index decision unit 51 converts, for the respective two customer companies B1 and B2, scored scores of the plurality of fixed items into relative values that indicates a relative relation between the customer companies B1 and B2. To be specific, the group index decision unit 51 calculates an average of scores of the plurality of fixed items, and decides values obtained by subtracting the average score from the scores of the respective customer companies B1 and B2 to be the relative values.

The person index decision unit 53 decides a second relationship on the basis of the personal transaction information stored in the HDD 104. The personal transaction information includes the person identification information of a person belonging to the target company, the person identification information of a person belonging to the customer company, the position of the person belonging to the customer company, contact means, contact content, and date and time. The second relationship indicates the degree of connection of the person belonging to the target company A with the customer company B1 or B2. For example, the second relationship includes the number of connected persons, and connection strength.

The number of connected persons of the person belonging to the target company A with the customer company B1 is, for example, the number of persons who the person belonging to the target company A stays in touch, of persons belonging to the customer company B1. For example, the personal transaction information having the date and time included in a predetermined period, and including the company identification information of the target company A and the company identification information of the customer company, of the personal transaction information stored in the HDD 104, is extracted, and the number of the person identification information of the customer company of the extracted personal transaction information is decided to be the number of connected persons. When a plurality of pieces of the personal transaction information including the same person identification information is extracted, the plurality of pieces of personal transaction information including the same person identification information is counted as one person.

The connection strength of the person belonging to the target company A with the customer company B1 can be a value obtained by scoring contact between the person belonging to the target company A and the person belonging to the customer company B1 according to a predetermined evaluation criterion. For example, one piece of the transaction information is generated for one contact between the person belonging to the target company A and the person belonging to the customer company B1. Therefore, the person index decision unit 53 decides, using one piece of the transaction information, a value obtained by multiplying a sum of a score provided to the position of a person the person belonging to the target company A is in contact with and a score provided to the contact means of the contact, by a factor provided to the contact content as the purpose of the contact, to be the connection strength to the one contact. The person index decision unit 53 decides a total of one or more connection strengths respectively decided from one or more pieces of the transaction information including the person identification information of the person belonging to the target company A and the company identification information of the customer company B1, to be the connection strength of the person belonging to the target company A to the customer company B1.

A plurality of persons belongs to the target company A. Therefore, the person index decision unit 53 decides the second relationships with the respective customer companies B1 and B2, for each of the plurality of persons belonging to the target company A. For example, when deciding the second relationship of a certain person belonging to the target company A with the customer company B1, the person index decision unit 53 outputs a set of the person identification information for identifying the person belonging to the target company A, the company identification information of the customer company B1, and the second relationship, to the determination unit 50, as second relation information. Further, when deciding the second relationship of a certain person belonging to the target company A with the customer company B2, the person index decision unit 53 outputs a set of the person identification information for identifying the person belonging to the target company A, the company identification information of the customer company B2, and the second relationship, to the determination unit 50, as second relation information.

The person index decision unit 53 generates the second relation information at predetermined intervals. The predetermined interval can be arbitrarily decided, and can be, for example, one month or one week. The person index decision unit 53 includes a history storage unit 63. The history storage unit 63 stores history information in which the second relation information is associated with date and time when the second relationship has been decided, to the HDD 104.

The determination unit 50 is input the first relation information from the group index decision unit 51 and the second relation information from the person index decision unit 53. The determination unit 50 determines risks in the target company to the respective customer companies B1 and B2 on the basis of the first relationships and the second relationships. The second relationship includes the number of connected persons and the connection strength.

The determination unit 50 includes an index determination unit 55, a change determination unit 57, and a deviation determination unit 59. The index determination unit 55 compares either the number of connected persons or the connection strength with a reference decided on the basis of the first relationship to determine a risk. The index determination unit 55 includes a comparison unit 65. The comparison unit 65 compares the second relationship with a reference decided on the basis of the first relationship. The comparison unit 65 compares either the number of connected persons or the connection strength with the reference decided on the basis of the first relationship.

The comparison unit 65 is input the first relation information from the group index decision unit 51. Here, a case in which the first relation information including a first relationship G1 of the target company A with the customer company B1, and the first relation information including a first relationship G2 of the target company A with the customer company B2 are input will be described as an example.

<Risk Determination of Each Individual Person by Number of Connected Persons>

When determining a risk of each individual person by the number of connected persons, the comparison unit 65 changes a threshold T1 decided in advance to determine the risk of each individual person by the number of connected persons, using the respective first relationships in the respective customer company B1 and the customer company B2. To be specific, the comparison unit 65 employs a value obtained by multiplying the threshold T1 by the first relationship G1 of the customer company B1 as a reference T1B1 for the customer company B1, and employs a value obtained by multiplying the threshold T1 by the first relationship G2 of the customer company B2 as a reference T1B2 for the customer company B2.

The comparison unit 65 compares the number of connected persons with the customer company B1, with the reference T1B1, and compares the number of connected persons with the customer company B2, with the reference T1B2, for each of the plurality of persons belonging to the target company A. To be specific, the comparison unit 65 selects any person P of the plurality of persons belonging to the target company A, and compares the number of connected persons of the second relationship included in the second relation information including the person identification information of the person P and the company identification information of the customer company B1, with the reference T1B1 for the customer company B1. The index determination unit 55 determines that there is a risk of the person P to the customer company B1 when the number of connected persons of the person P with the customer company B1 is smaller than the reference T1B1 for the customer company B1, as a result of the comparison by the comparison unit 65.

When determining that there is a risk, the index determination unit 55 outputs a proposal instruction to the proposal unit 43. The proposal instruction includes the person identification information of the person belonging to the target company A, who has been determined to have a risk, the company identification information of the customer company B1, and a determination reference. The determination reference here is the number of connected persons.

Similarly, the comparison unit 65 selects any person P of the plurality of persons belonging to the target company A, and compares the number of connected persons of the second relationship included in the second relation information including the person identification information of the person P and the company identification information of the customer company B2, with the reference T1B2 for the customer company B2. The index determination unit 55 determines that there is a risk of the person P to the customer company B2 when the number of connected persons of the person P with the customer company B2 is smaller than the reference T1B2 for the customer company B2, as a result of the comparison by the comparison unit 65.

When determining that there is a risk, the index determination unit 55 outputs a proposal instruction to the proposal unit 43. The proposal instruction includes the person identification information of the person belonging to the target company A, who has been determined to have a risk, the company identification information of the customer company B2, and a determination reference. The determination reference here is the number of connected persons outside the company.

<Risk Determination by Number of Persons of Target Company>

When determining a risk by the number of a plurality of persons belonging to the target company A, the comparison unit 65 changes a threshold T2 decided in advance to determine the risk by the number of a plurality of persons belonging to the target company A, using the respective first relationships of the respective customer companies B1 and B2. To be specific, the comparison unit 65 employs a value obtained by multiplying the threshold T2 by the first relationship G1 of the customer company B1 as a reference T2B1 for the customer company B1, and employs a value obtained by multiplying the threshold T2 by the first relationship G2 of the customer company B2 as a reference T2B2 for the customer company B2.

The comparison unit 65 compares the number of persons having connection with the customer company B1, of the plurality of persons belonging to the target company A, with the reference T2B1, and compares the number of persons having connection with the customer company B2, of the plurality of persons belonging to the target company A, with the reference T2B2. To be specific, the comparison unit 65 extracts the second relation information including the company identification information of the target company A and the company identification information of the customer company B1, and identifies the persons of the target company A included in the extracted second relation information to decide the number of persons belonging to the target company A and having connection with the customer company B1. The comparison unit 65 compares the number of persons belonging to the target company A and having connection with the customer company B1, with the reference T2B1 for the customer company B1. The index determination unit 55 determines that there is a risk to the number of persons belonging to the target company A and having connection with the customer company B1 when the number of persons belonging to the target company A and having connection with the customer company B1 is smaller than the reference T2B1 for the customer company B1, as a result of the comparison by the comparison unit 65.

When determining that there is a risk, the index determination unit 55 outputs a proposal instruction to the proposal unit 43. The proposal instruction includes the company identification information of the target company A determined to have a risk, the company identification information of the customer company B1, and a determination reference. The determination reference here is the number of connected persons.

Similarly, the comparison unit 65 extracts the second relation information including the company identification information of the target company A and the company identification information of the customer company B2, and identifies the persons of the target company A included in the extracted second relation information to decide the number of persons belonging to the target company A and having connection with the customer company B2. The comparison unit 65 compares the number of persons belonging to the target company A and having connection with the customer company B2, with the reference T2B2 for the customer company B2. The index determination unit 55 determines that there is a risk to the number of persons belonging to the target company A and having connection with the customer company B2 when the number of persons belonging to the target company A and having connection with the customer company B2 is smaller than the reference T2B2 for the customer company B2, as a result of the comparison by the comparison unit 65.

When determining that there is a risk, the index determination unit 55 outputs a proposal instruction to the proposal unit 43. The proposal instruction includes the company identification information of the target company A determined to have a risk, the company identification information of the customer company B2, and a determination reference. The determination reference here is the number of connected persons outside the company.

<Risk Determination of Each Individual Person by Connection Strength>

When determining a risk of each individual person by the connection strength, the comparison unit 65 changes a threshold T3 decided in advance to determine the risk of each individual person by the connection strength, using the respective first relationships of the respective customer companies B1 and B2. To be specific, the comparison unit 65 employs a value obtained by multiplying the threshold T3 by the first relationship G1 of the customer company B1 as a reference T3B1 for the customer company B1, and employs a value obtained by multiplying the threshold T3 by the first relationship G2 of the customer company B2 as a reference T3B2 for the customer company B2.

The comparison unit 65 compares the connection strength of the customer company B1 with the reference T3B1, and compares the connection strength of the customer company B2 with the reference T3B2, for each of the plurality of persons belonging to the target company A. To be specific, the comparison unit 65 selects any person P of the plurality of persons belonging to the target company A, and compares the connection strength of the second relationship included in the second relation information including the person identification information of the person P and the company identification information of the customer company B1, with the reference T3B1 for the customer company B1. The index determination unit 55 determines that there is a risk of the person P to the customer company B1 when the connection strength of the person P with the customer company B1 is smaller than the reference T3B1 for the customer company B1, as a result of the comparison by the comparison unit 65.

When determining that there is a risk, the index determination unit 55 outputs a proposal instruction to the proposal unit 43. The proposal instruction includes the person identification information of the person belonging to the target company A, who has been determined to have a risk, the company identification information of the customer company B1, and a determination reference. The determination reference here is the personal connection strength.

Similarly, the comparison unit 65 selects any person P of the plurality of persons belonging to the target company A, and compares the connection strength of the second relationship included in the second relation information including the person identification information of the person P and the company identification information of the customer company B2, with the reference T3B2 for the customer company B2. The index determination unit 55 determines that there is a risk of the person P to the customer company B2 when the connection strength of the person P with the customer company B2 is smaller than the reference T3B2 for the customer company B2, as a result of the comparison by the comparison unit 65.

When determining that there is a risk, the index determination unit 55 outputs a proposal instruction to the proposal unit 43. The proposal instruction includes the person identification information of the person belonging to the target company A, who has been determined to have a risk, the company identification information of the customer company B2, and a determination reference. The determination reference here is the personal connection strength.

<Risk Determination of Target Company by Connection Strength>

When determining a risk of the target company A by the connection strength, the comparison unit 65 changes a threshold T4 decided in advance to determine the risk of the target company by the connection strength, using the respective first relationships of the respective customer companies B1 and B2. To be specific, the comparison unit 65 employs a value obtained by multiplying the threshold T4 by the first relationship G1 of the customer company B1 as a reference T4B1 for the customer company B1, and employs a value obtained by multiplying the threshold T4 by the first relationship G2 of the customer company B2 as a reference T4B2 for the customer company B2.

The comparison unit 65 compares a total of the connection strengths of the plurality of respective persons belonging to the target company A with the customer company B1, with the reference T4B1, and compares a total of the connection strengths of the plurality of respective persons belonging to the target company A with the customer company B2, with the reference T4B2. To be specific, the comparison unit 65 extracts all the second relation information including the person identification information of any of the plurality of persons belonging to the target company A and the company identification information of the customer company B1, and calculates a total of the connection strengths of the second relationships respectively included in the plurality of extracted pieces of second relation information. The comparison unit 65 compares the calculated total of the connection strengths, by the reference T4B1 for the customer company B1. The index determination unit 55 determines that there is a risk in the target company A to the customer company B1 when the total of the connection strengths is smaller than the reference T4B1, as a result of the comparison by the comparison unit 65.

When determining that there is a risk, the index determination unit 55 outputs a proposal instruction to the proposal unit 43. The proposal instruction includes the company identification information of the target company A determined to have a risk, the company identification information of the customer company B1, and a determination reference. The determination reference here is the connection strength of the company.

Similarly, the comparison unit 65 extracts all the second relation information including the person identification information of any of the plurality of persons belonging to the target company A and the company identification information of the customer company B2, and calculates a total of the connection strengths of the second relationships respectively included in the plurality of extracted pieces of second relation information. The comparison unit 65 compares the calculated total of the connection strengths, by the reference T4B2 for the customer company B2. The index determination unit 55 determines that there is a risk in the target company A to the customer company B2 when the total of the connection strengths is smaller than the reference T4B2, as a result of the comparison by the comparison unit 65.

When determining that there is a risk, the index determination unit 55 outputs a proposal instruction to the proposal unit 43. The proposal instruction includes the company identification information of the target company A determined to have a risk, the company identification information of the customer company B2, and a determination reference. The determination reference here is the connection strength of the company.

The change determination unit 57 is input the first relation information from the group index decision unit 51 and the second relation information from the person index decision unit 53. The change determination unit 57 determines risks in the target company to the respective customer companies B1 and B2 on the basis of temporal change of the first relationship and the second relationship. The change determination unit 57 decides the temporal change of the second relationship, using the second relationship included in the second relation information input from the person index decision unit 53 and the second relationship included in the history information stored in the HDD 104. The second relationship includes the number of connected persons and the connection strength. The index determination unit 55 compares the temporal change of either the number of connected persons or the connection strength, with a reference decided on the basis of the first relationship, to determine the risk.

The change determination unit 57 includes a change comparison unit 67. The change comparison unit 67 compares change of the second relationship with a reference decided on the basis of the first relationship. The change comparison unit 67 compares either change of the number of connected persons or change of the connection strength, with a reference decided on the basis of the first relationship.

The change comparison unit 67 decides the first relationship G1 of the customer company B1 and the first relationship G2 of the customer company B2 on the basis of the first relationship included in the first relation information input from the group index decision unit 51, similarly to the comparison unit 65.

<Risk Determination by Decreasing Rate of Number of Connected Persons>

The change comparison unit 67 extracts the second relation information including the company identification information of the target company A and the company identification information of the customer company B1, from the second relation information input from the person index decision unit 53, and identifies the persons of the target company A included in the extracted second relation information to decide the number of current persons belonging to the target company A and having connection with the customer company B1. Further, the change comparison unit 67 extracts the second relation information including the company identification information of the target company A and the company identification information of the customer company B1, from the history information stored in the HDD 104, and identifies the persons of the target company A included in the extracted second relation information to decide the number of past persons belonging to the target company A and having connection with the customer company B1. The change comparison unit 67 calculates a decreasing rate of the number of connected persons to the customer company B1 from the number of past persons belonging to the target company A and having connection with the customer company B1, and the number of current persons belonging to the target company A and having connection with the customer company B1. Similarly, the change comparison unit 67 calculates a decreasing rate of the number of connected persons to the customer company B2.

When determining a risk by the decreasing rate of the number of connected persons, the change comparison unit 67 changes a threshold T5 decided in advance to determine the risk by the decreasing rate of the number of connected persons, using the respective first relationships G1 and G2 of the respective customer companies B1 and B2, using the next formula (1), into references T5B1 and T5B2:

T5B1=T5−T5(G1−1), T5B2=T5−T5(G2−1) (1)

The change comparison unit 67 compares the decreasing rate of the number of connected persons to the customer company B1, with the reference T5B1. The change comparison unit 67 determines that there is a risk in the number of persons having connection with the customer company B1 when the decreasing rate of the number of connected persons to the customer company B1 is larger than the reference T5B1. When determining that there is a risk, the change determination unit 57 outputs a proposal instruction to the proposal unit 43. The proposal instruction includes the company identification information of the target company A determined to have a risk, the company identification information of the customer company B1, and a determination reference. The determination reference here is a decrease in the number of connected persons.

The change comparison unit 67 compares the decreasing rate of the number of connected persons to the customer company B2, with the reference T5B2. The change determination unit 57 determines that there is a risk in the number of persons having connection with the customer company B2 when the decreasing rate of the number of connected persons to the customer company B2 is larger than the reference T5B2. When determining that there is a risk, the change determination unit 57 outputs a proposal instruction to the proposal unit 43. The proposal instruction includes the company identification information of the target company A determined to have a risk, the company identification information of the customer company B2, and a determination reference. The determination reference here is a decrease in the number of connected persons.

<Risk Determination by Duration of Decrease in Number of Connected Persons>

The change comparison unit 67 does not immediately determine that there is a risk when the decreasing rate of the number of connected persons to the customer company B1 is larger than the reference T5B1, and determines that there is a risk when a predetermined period passes without increasing the number of connected persons to the customer company B1. The same applies to the customer company B2, and thus here the customer company B1 will be described as an example.

When the decreasing rate of the number of connected persons to the customer company B1 is larger than the reference T5B1, the change comparison unit 67 stores date and time of that point, and the number of connected persons to the customer company B1, to the HDD 104.

When determining a risk by duration of the decrease in the number of connected persons, the change comparison unit 67 changes a threshold T6 decided in advance to determine the risk by the duration of the decrease in the number of connected persons, using the first relationship G1 of the customer company B1. To be specific, the comparison unit 65 employs a value obtained by multiplying the threshold T6 by the first relationship G1 of the customer company B1 as a reference T6B1 for the customer company B1.

The change determination unit 57 determines that there is a risk in the number of persons having connection with the customer company B1 when an elapsed time from the date and time stored in the HDD 104 becomes the reference T6B1 or more. When determining that there is a risk, the change determination unit 57 outputs a proposal instruction to the proposal unit 43. The proposal instruction includes the company identification information of the target company A determined to have a risk, the company identification information of the customer company B1, and a determination reference. The determination reference here is a decrease period of the number of connected persons.

<Risk Determination by Decreasing Rate of Connection Strength>

The change comparison unit 67 selects any person P of the plurality of persons belonging to the target company A, extracts the second relation information including the person identification information of the person P and the company identification information of the customer company B1, from the second relation information input to the person index decision unit 53, and decides the connection strength of the second relationship included in the extracted second connection information, to be current connection strength of the person P to the customer company B1. The change comparison unit 67 selects any person P of the plurality of persons belonging to the target company A, extracts the second relation information including the person identification information of the person P and the company identification information of the customer company B1 from the history information stored in the HDD 104, and decides the connection strength of the second relationship included in the extracted second connection information, to be past connection strength of the person P to the customer company B1. The change comparison unit 67 calculates the decreasing rate of the connection strength of the person P to the customer company B1 from the past connection strength of the person P to the customer company B1 and the current connection strength of the person P to the customer company B1. Similarly, the change comparison unit 67 calculates the decreasing rate of the connection strength of the person P to the customer company B2.

When determining a risk by the decreasing rate of the connection strength, the change comparison unit 67 changes a threshold T7 decided in advance to determine the risk by the decreasing rate of the connection strength, using the respective first relationships G1 and G2 of the respective customer companies B1 and B2, using the next formula (2), into references T7B1 and T7B2:

T7B1=T7−T7(G1−1), T7B2=T7−T7(G2−1) (2)

The change comparison unit 67 compares the decreasing rate of the connection strength of the person P to the customer company B1, with the reference T7B1. When the decreasing rate of the connection strength of the person P to the customer company B1 is larger than the reference T7B1, the change determination unit 57 determines that there is a risk of the person P to the customer company B1. When determining that there is a risk, the change determination unit 57 outputs a proposal instruction to the proposal unit 43. The proposal instruction includes the company identification information of the target company A determined to have a risk, the company identification information of the customer company B1, and a determination reference. The determination reference here is a decrease in the connection strength.

The change comparison unit 67 compares the decreasing rate of the connection strength of the person P to the customer company B2, with the reference T7B2. When the decreasing rate of the connection strength of the person P to the customer company B2 is larger than the reference T7B2, the change determination unit 57 determines that there is a risk of the person P to the customer company B2. When determining that there is a risk, the change determination unit 57 outputs a proposal instruction to the proposal unit 43. The proposal instruction includes the company identification information of the target company A determined to have a risk, the company identification information of the customer company B2, and a determination reference. The determination reference here is a decrease in the connection strength.

The deviation determination unit 59 is input the first relation information from the group index decision unit 51, and the second relation information from the person index decision unit 53. The deviation determination unit 59 determines risks in the target company to the respective customer companies B1 and B2 on the basis of the first relationship and deviation of the second relationship. The second connection includes the number of connected persons and the connection strength. The deviation determination unit 59 compares either the number of connected persons deviation or connection strength deviation, with a reference decided on the basis of the first relationship, to determine the risk.

The deviation determination unit 59 includes a deviation comparison unit 69. The deviation comparison unit 69 compares the deviation of the second relationship, with the reference decided on the basis of the first relationship. The deviation comparison unit 69 compares either the number of connected persons deviation or the connection strength deviation, with the reference decided on the basis of the first relationship.

The deviation comparison unit 69 extracts the first relation information including the company identification information of the target company A and the company identification information of the customer company B1, from the first relation information input to the group index decision unit 51, to decide the first relationship of the target company A with the customer company B1. The deviation comparison unit 69 extracts the first relation information including the company identification information of the target company A and the company identification information of the customer company B2, to decide the first relationship of the target company A with the customer company B2.

<Risk Determination by Deviation of Number of Connected Persons>

The deviation comparison unit 69 determines existence or non-existence of deviation of the numbers of connected persons to the customer company B1 among the plurality of persons belonging to the target company A. The deviation of the number of connected persons is referred to as the number of persons deviation rate. The number of persons deviation rate is a ratio of the number of connected persons of each of the plurality of persons to the customer company B1, to a cumulative total number of persons. For example, when persons P1, P2, and P3 belong to the target company A, and the numbers of connected portions of the persons P1, P2, and P3 to the customer company B1 are Q11, Q12, and Q13, respectively, the number of persons deviation rate of the person P1 is Q11/(Q11+Q12+Q13), the number of persons deviation rate of the person P2 is Q12/(Q11+Q12+Q13), and the number of persons deviation rate of the person P3 is Q13/(Q11+Q12+Q13).

When determining a risk by the deviation of the number of connected persons, the deviation comparison unit 69 changes a threshold T8 decided in advance to determine the risk by the deviation of the number of connected persons, using the respective first relationships of the respective customer companies B1 and B2. To be specific, the comparison unit 65 employs a value obtained by multiplying the threshold T8 by the first relationship G1 of the customer company B1 as a reference T8B1 for the customer company B1, and employs a value obtained by multiplying the threshold T8 by the first relationship G2 of the customer company B2 as a reference T8B2 for the customer company B2.

The deviation comparison unit 69 decides the numbers of connected persons to the customer company B1, of the plurality of respective persons belonging to the target company A, decides the respective number of persons deviation rates of the respective persons, and compares a maximum value of the number of persons deviation rates with the reference T8B1. The deviation determination unit 59 determines that there is a risk to the customer company B1 when the maximum value of the number of persons deviation rates is larger than the reference T8B1 for the customer company B1 as a result of the comparison of the deviation comparison unit 69. When determining that there is a risk, the deviation determination unit 59 outputs a proposal instruction to the proposal unit 43. The proposal instruction includes the company identification information of the target company A determined to have a risk, the company identification information of the customer company B1, and a determination reference. The determination reference here is the deviation of the number of persons.

Similarly, the deviation comparison unit 69 decides the numbers of connected persons to the customer company B2, of t plurality of respective persons belonging to the target company A, decides the respective number of persons deviation rates of the respective persons, and compares a maximum value of the number of persons deviation rates with the reference T8B2. The deviation determination unit 59 determines that there is a risk to the customer company B2 when the maximum value of the number of persons deviation rates is larger than the reference T8B2 for the customer company B2 as a result of the comparison of the deviation comparison unit 69. When determining that there is a risk, the deviation determination unit 59 outputs a proposal instruction to the proposal unit 43. The proposal instruction includes the company identification information of the target company A determined to have a risk, the company identification information of the customer company B2, and a determination reference. The determination reference is here the deviation of the number of persons.

<Risk Determination by Deviation of Connection Strength>

The deviation comparison unit 69 determines existence or non-existence of deviation of the connection strengths to the customer company B1 among the plurality of persons belonging to the target company A. The deviation of the connection strength is referred to as strength deviation rate. The strength deviation rate is a ratio of the connection strength of each of the plurality of persons to the customer company B1, to cumulative strength. For example, the persons P1, P2, and P3 belong to the target company A, and the connection strengths of the persons P1, P2, and P3 to the customer company B2 are Q21, Q22, and Q23. The strength deviation rate of the person P1 is Q21/(Q21+Q22+Q23), the strength deviation rate of the person P2 is Q22/(Q21+Q22+Q23), and the strength deviation rate of the person P3 is Q23/(Q21+Q22+Q23).

When determining a risk by the deviation of the connection strength, the deviation comparison unit 69 changes a threshold T9 decided in advance to determine the risk by the deviation of the connection strength, using the respective first relationships of the respective customer companies B1 and B2. To be specific, the comparison unit 65 employs a value obtained by multiplying the threshold T9 by the first relationship G1 of the customer company B1 as a reference T9B1 for the customer company B1, and employs a value obtained by multiplying the threshold T9 by the first relationship G2 of the customer company B2 as a reference T9B2 for the customer company B2.

The deviation comparison unit 69 decides the connection strengths to the customer company B1, of the plurality of respective persons belonging to the target company A, decides strength deviation rates of the respective persons, and compares a maximum value of the strength deviation rates with the reference T9B1. The deviation determination unit 59 determines that there is a risk to the customer company B1 when the maximum value of the strength deviation rate is larger than the reference T9B1 for the customer company B1 as a result of the comparison of the deviation comparison unit 69. When determining that there is a risk, the deviation determination unit 59 outputs a proposal instruction to the proposal unit 43. The proposal instruction includes the company identification information of the target company A determined to have a risk, the company identification information of the customer company B1, and a determination reference. The determination reference here is the deviation of the connection strength.

Similarly, the deviation comparison unit 69 decides the connection strengths to the customer company B2, of the plurality of respective persons belonging to the target company A, decides strength deviation rates of the respective persons, and compares a maximum value of the strength deviation rates with the reference T9B2. The deviation determination unit 59 determines that there is a risk to the customer company B2 when the maximum value of the strength deviation rates is larger than the reference T9B2 for the customer company B2 as a result of the comparison of the deviation comparison unit 69. When determining that there is a risk, the deviation determination unit 59 outputs a proposal instruction to the proposal unit 43. The proposal instruction includes the company identification information of the target company A determined to have a risk, the company identification information of the customer company B2, and a determination reference. The determination reference here is the deviation of the connection strength.

The proposal unit 43 decides and notifies proposal content in response to the input of the proposal instruction from any of the index determination unit 55, the change determination unit 57, and the deviation determination unit 59. The proposal content is stored in the HDD 104 in association with the determination reference included in the proposal instruction.

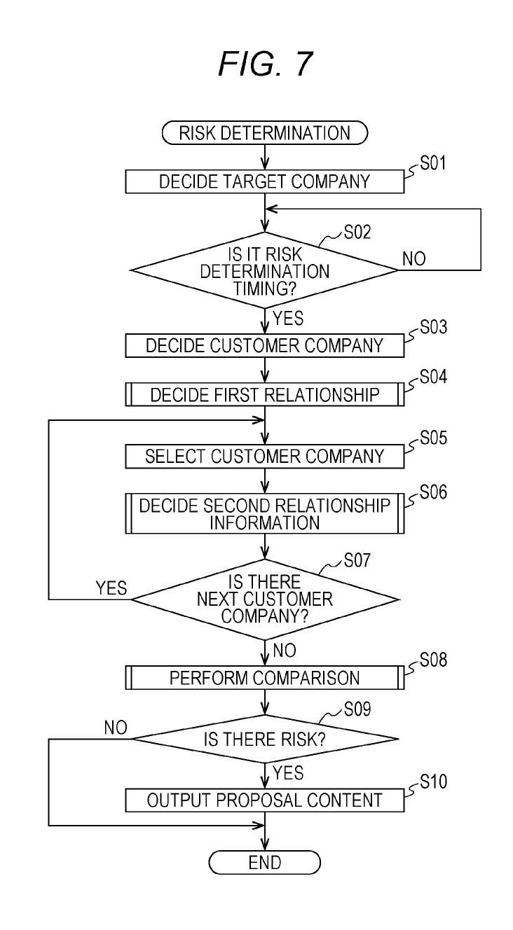

FIG. 7 is a flowchart illustrating an example of a flow of risk determination processing. The risk determination processing is processing executed by the CPU 101 when the CPU 101 included in the risk determination device 100 executes the risk determination program stored in the ROM 102, the HDD 104, or the CD-ROM 109. Referring to FIG. 7, the CPU 101 included in the risk determination device 100 decides the target company (step S01). For example, the CPU 101 selects, in order, a plurality of companies registered in advance to decide the selected company to be the target company. Alternatively, the CPU 101 may decide a company specified by the user who operates the risk determination device 100 to be the target company. For example, when the risk determination device 100 receives the command that requests transmission of the home page from the PC 200, the risk determination device 100 returns the home page stored in the HDD 104 in advance to the PC 200 that has transmitted the command. The PC 200 can input an operation according to the received home page and becomes able to operate the risk determination device 100. The user who operates the PC 200 can specify the target company through the home page transmitted by the risk determination device 100 or a web page transmitted after the transmission of the home page. Further, a user who can use the risk determination service provided by the risk determination device 100 and a company associated with the user may be stored in advance and the risk determination device 100 may authenticate the user who operates the PC 200, and the company associated with the user may be decided to be the target company upon authentication of the user. Hereinafter, a case in which the company A to which the user who operates the PC 200 belongs is the target company, and the two companies B1 and B2 with which the target company A transacts business are the customer companies will be described as an example.

In next step S02, the CPU 101 determines whether it is risk determination timing. The risk determination timing is a time to determine a risk and is decided for each target company. For example, a time when execution of the risk determination is instructed by the user may be employed as the risk determination timing. The processing is in a stand-by state until current date and time become the risk determination timing, and when the current date and time is the risk determination timing, the CPU 101 advances the processing to step S01.

When the timing to perform risk determination is decided in advance for the target company, for example, when the risk determination timing is decided to be 9 AM on every Monday, the CPU 101 may decide the target company when the current date and time become the timing (step S01), and may execute step S03 and subsequent processing.

In step S03, the CPU 101 decides the customer company. In step S01, the CPU 101 decides the customer company corresponding to the target company by reference to the customer company information stored in the HDD 104, corresponding to the decided target company. When there is a plurality of the customer companies, the CPU 101 decides the plurality of customer companies.

In next step S04, the CPU 101 executes first relationship decision processing, and advances the processing to step S05. Although details will be described below, the first relationship decision processing is processing of deciding the first relationships that indicate the relative relations between the target company and the respective customer companies.

In step S05, the CPU 101 selects the customer company serving as a target of the risk determination, and advances the processing to step S06. In step S06, the CPU 101 executes second relationship decision processing, and advances the processing to step S07. Although details will be described below, the second relationship decision processing is processing of deciding the second relationship of each of one or more persons belonging to the target company with the customer company serving as the target of the risk determination. The second relationship includes the number of connected persons and the connection strength.

In step S07, the CPU 101 determines whether there is an unselected customer company as the target of the risk determination in step S05, of the customer companies decided in step S03. When there is the unselected customer company as the target of the risk determination, the CPU 101 returns the processing to step S05. Otherwise, the CPU 101 advances the processing to step S08.

In step S08, the CPU 101 executes comparison processing, and advances the processing to step S09. In step S09, the CPU 101 determines whether a result of the execution of the comparison processing indicates a risk. When the result is decided to indicate a risk, the CPU 101 advances the processing to step S10. Otherwise, the CPU 101 skips step S10 and terminates the processing. In step S10, the CPU 101 outputs proposal content and terminates the processing. The proposal content is measures decided in advance to the result of the comparison processing determined to indicate a risk.

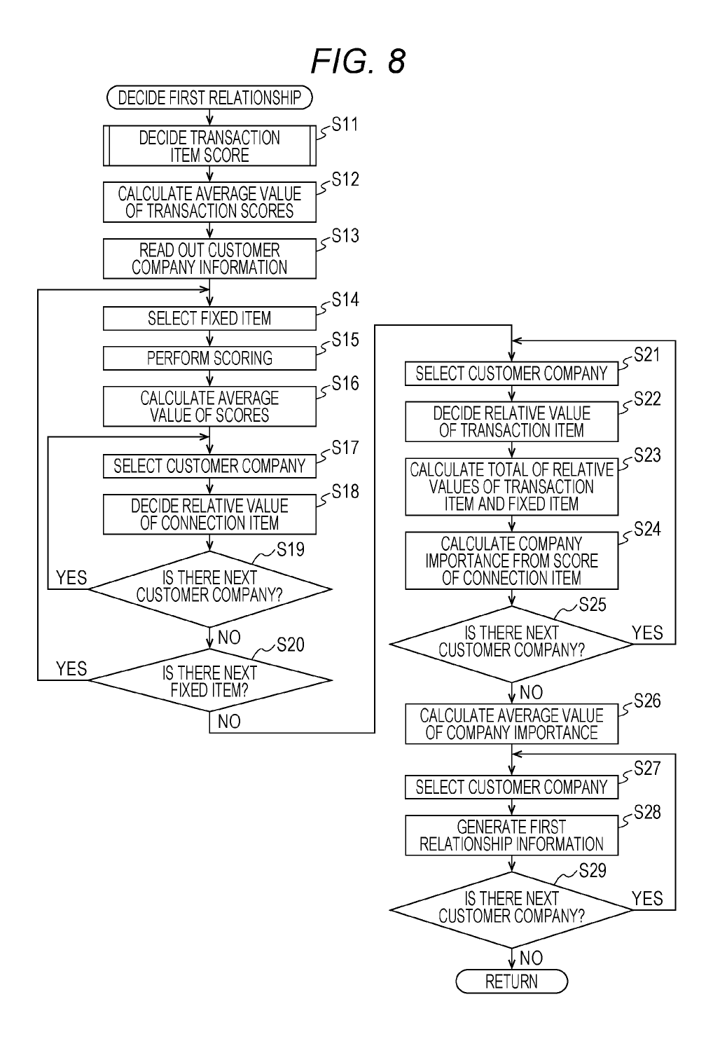

FIG. 8 is a flowchart illustrating an example of a flow of the first relationship decision processing. The first relationship decision processing is processing executed in step S04 of the risk determination processing. The target company and one or more customer companies corresponding to the target company have been decided before the first relationship decision processing is executed. In the first relationship decision processing, the CPU 101 decides the first relationship with each customer company, using the customer company information and the company transaction information stored in the HDD 104, corresponding to the target company. Referring to FIG. 8, the CPU 101 executes transaction item score decision processing.

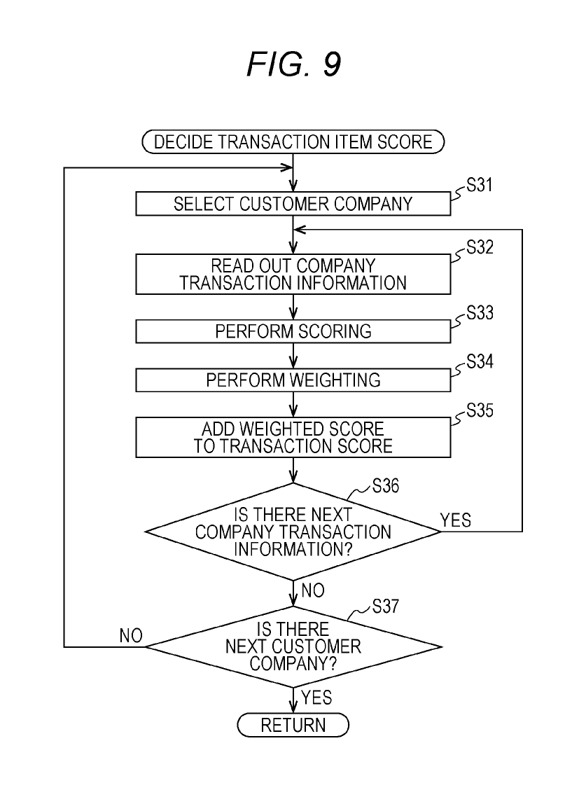

FIG. 9 is a flowchart illustrating an example of a flow of the transaction item score decision processing. Referring to FIG. 9, the CPU 101 selects the customer company serving as a target of calculation of the transaction item score (step S31). The CPU 101 selects one of the one or more customer companies decided in step S03 of the risk determination processing. In next step S32, the CPU 101 reads out the company transaction information including the company identification information of the customer company from the HDD 104, corresponding to the target company. Then, the CPU 101 provides the score corresponding to the transaction amount (step S33). The CPU 101 decides the score decided in advance according to the transaction amount. Further, the CPU 101 weights the score according to existence or non-existence of the core product (step S34). The weighting is performed in a case of a transaction of the core product, but the weighting is not performed in a case of not a transaction of the core product. When weighting, the CPU 101 multiplies the score by the factor decided in advance. In next step S35, the CPU 101 adds the score decided in step S33 or the weighted score when weighted in step S34 to the transaction score, and advances the processing to step S36. In step S36, the CPU 101 determines whether there is the company transaction information including the company identification information of the customer company and is unread company transaction information from the HDD 104 in step S32, corresponding to the target company. When there is such company transaction information, the CPU 101 returns the processing to step S32. Otherwise, the CPU 101 advances the processing to step S37. In step S37, the CPU 101 determines whether there is an unselected customer company as the target of the calculation of the transaction item score in step S31. When there is the unselected customer company, the CPU 101 returns the processing to step S31. Otherwise, the CPU 101 returns the processing to the first relationship decision processing.

Referring back to FIG. 8, the CPU 101 executes transaction item score decision processing to calculate the transaction scores of one or more customer companies. In step S12, the CPU 101 calculates the average value of the transaction scores, and advances the processing to step S13.

In step S13, the CPU 101 reads out the customer company information. The CPU 101 reads out all the customer company information including the company identification information of one or more customer companies from the HDD 104, corresponding to the target company A. In next step S14, the CPU 101 selects one of the plurality of fixed items included in the customer company information as a processing target. Then, the CPU 101 scores the selected fixed item, for each customer company. The CPU 101 converts the value set to the fixed item into the score decided in advance for the value. In next step S16, the CPU 101 calculates the average value of the scores provided to the fixed items, and advances the processing to step S17.

In step S17, the CPU 101 selects the customer company. The CPU 101 selects one of the one or more customer companies decided in step S03 of the risk determination processing. In next step S18, the CPU 101 decides the relative value. The CPU 101 decides a value obtained by subtracting the average value calculated in step S16 from the scored score in step S15, for the fixed item selected in step S14, to be the relative value, for the customer company selected in step S17. In next step S19, the CPU 101 determines whether there is an unselected customer company in step S17. When there is the unselected customer company, the CPU 101 returns the processing to step S17. Otherwise, the CPU 101 advances the processing to step S20. In step S20, the CPU 101 determines whether there is an unselected fixed item in step S14. When there is the unselected fixed item, the CPU 101 returns the processing to step S14. When there is no unselected fixed item, the CPU 101 advances the processing to step S21.

In step S21, the CPU 101 selects the customer company. The CPU 101 selects one of the one or more customer companies decided in step S03 of the risk determination processing. In next step S22, the CPU 101 decides the relative value of the transaction item, and advances the processing to step S23. The score of the transaction item of the selected customer company has been decided in step S11, and the average value of the transaction items has been decided in step S12. The CPU 101 decides a value obtained by subtracting the average value from the score of the transaction item of the customer company to be the relative value of the transaction item. In step S23, the CPU 101 calculates the total of the relative value of the transaction item and the relative values of the respective fixed items. Then, the CPU 101 calculates the company importance (step S24), and advances the processing to step S25. The CPU decides a value obtained by multiplying the total of the relative values calculated in step S23 by the score of the relation item to be the company importance. In step S25, the CPU 101 determines whether there is an unselected customer company in step S21. When there is the unselected customer company, the CPU 101 returns the processing to step S21. When there is no unselected customer company, the CPU 101 advances the processing to step S26.

In step S26, the CPU 101 calculates the average value of the company importances. The company importances have been calculated in step S24 for the respective one or more customer companies. In next step S27, the CPU 101 selects the customer company, and advances the processing to step S28. The CPU 101 selects one of the one or more customer companies decided in step S03 of the risk determination processing. In step S28, the CPU 101 generates the first relation information, and advances the processing to step S29. The CPU 101 decides a value obtained by dividing the company importance calculated in step S24 for the customer company selected as the processing target by the average value calculated in step S26 to be the first relationship. Then, the CPU 101 generates the first relation information including the company identification information of the target company, the company identification information of the customer company, and the first relationship. In step S29, the CPU 101 determines whether there is an unselected customer company in step S27. When there is the unselected customer company, the CPU 101 returns the processing to step S27. When there is no unselected customer company, the CPU 101 returns the processing to the risk determination processing.

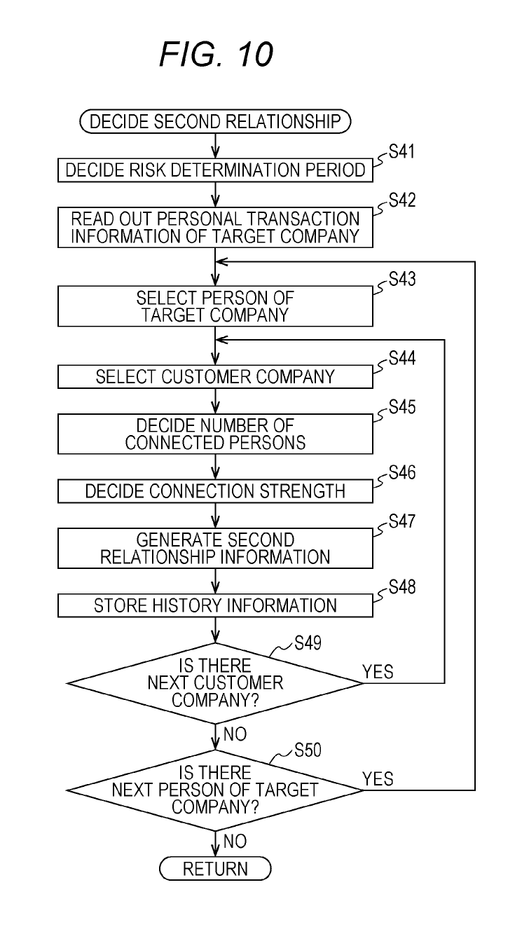

FIG. 10 is a flowchart illustrating an example of a flow of the second relationship decision processing. The second relationship decision processing is processing executed in step S06 of the risk determination processing. Referring to FIG. 10, the CPU 101 decides the risk determination period (step S41), and advances the processing to step S42. The CPU 101 decides a period serving as a target of the risk determination. The risk determination period may just be decided to be a period from the current date and time to before a predetermined period, for example. Alternatively, a period in units of one month may be decided in advance. Alternatively, a user who operates the PC 200 may specify the risk determination period.

In step S42, the CPU 101 reads out the personal transaction information of the target company. The CPU 101 reads out all the personal transaction information generated within the risk determination period from the HDD 104, corresponding to the person belonging to the target company. The personal transaction information includes the person identification information of the person belonging to the target company, the person identification information of the person belonging to the customer company, the position of the person belonging to the customer company, the contact means, the contact content, and the date and time. The person identification information includes the company identification information of the company to which the person belongs, and the personal identification information for identifying the person. Therefore, the CPU 101 reads out the personal transaction information including the company identification information of the target company and the date and time within the risk determination period from the HDD 104.

In next step S43, the CPU 101 selects the person of the target company. The CPU 101 identifies all the one or more persons belonging to the target company, using the person identification information of a plurality of pieces of the personal transaction information read out in step S42, and selects one of the identified one or more persons.

In next step S44, the CPU 101 selects the customer company. The CPU 101 selects one of the one or more customer companies decided in step S03 of the risk determination processing. Then, the CPU 101 decides the number of connected persons (step S45). The CPU 101 extracts the personal transaction information including the person identification information selected in step S43 and the company identification information of the customer company selected in step S44, of the plurality of pieces of personal transaction information read out in step S42. Then, the CPU 101 decides the number of the person identification information of the persons belonging to the target company of the extracted personal transaction information to be the number of connected persons.

In next step S46, the CPU 101 decides the connection strength. The CPU 101 calculates the connection strength for each personal transaction information including the person identification information selected in step S43 and the company identification information of the customer company selected in step S44, and decides a total of the calculated connection strengths to be the connection strength of the person selected in step S43 for the customer company. To be specific, the CPU 101 converts the position and the contact means of the personal transaction information into the scores decided in advance, and converts the contact content into the factor decided in advance. For example, the CPU 101 decides a value obtained by multiplying the total of the score of the position and the score of the contact means by the factor of the contact content to be the connection strength for one transaction case. The CPU 101 decides a value obtained by totaling the connection strengths decided for all the personal transaction information to be the connection strength to the customer company.

In next step S47, the CPU 101 generates the second relation information, and advances the processing to step S48. The second relation information includes the person identification information of the person selected in step S43, the company identification information of the customer company selected in step S44, the number of connected persons decided in step S45, and the connection strength decided in step S46. Then, the CPU 101 stores the history information in which the current date and time is associated with the generated second relation information to the HDD 104, and advances the processing to step S49.

In step S49, the CPU 101 determines whether there is an unselected customer company as the processing target in step S44. When there is the unselected customer company as the processing target, the CPU 101 returns the processing to step S44. When there is no unselected customer company, the CPU 101 advances the processing to step S50. In step S50, the CPU 101 determines whether there is an unselected person as the processing target in step S43. When there is the unselected person as the processing target, the CPU 101 returns the processing to step S43. When there is no unselected person, the CPU 101 returns the processing to the risk determination processing.

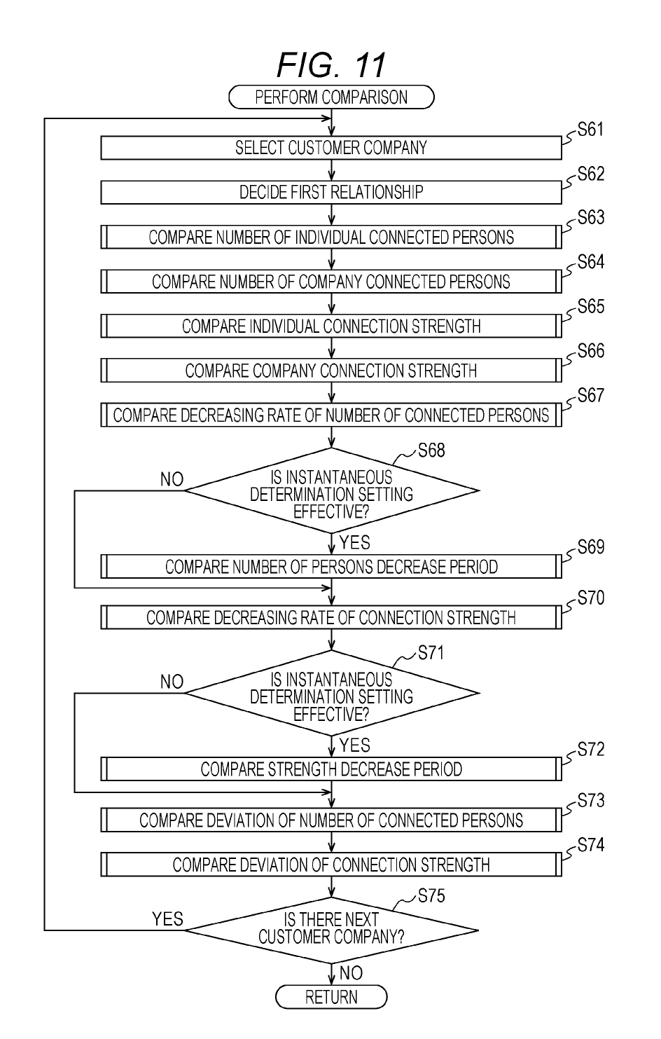

FIG. 11 is a flowchart illustrating an example of a flow of the comparison processing. The comparison processing is processing executed in step S08 of the risk determination processing. The first relationship decision processing has been executed (step S04) before the comparison processing is executed, and the first relationships of the respective one or more customer companies that transact business with the target company have been decided. Referring to FIG. 11, CPU 101 selects the customer company (step S61). The CPU 101 selects one of the one or more customer companies decided in step S03 of the risk determination processing. Then, the CPU 101 decides the first relationship decided corresponding to the selected customer company (step S62).

In next step S63, the CPU 101 executes number of individual connected persons comparison processing, and advances the processing to step S64. In step S64, the CPU 101 executes number of company connected persons comparison processing, and advances the processing to step S65. In step S65, the CPU 101 executes individual connection strength comparison processing, and advances the processing to step S66. In step S66, the CPU 101 executes company connection strength comparison processing, and advances the processing to step S67.

In step S67, the CPU 101 executes number of connected persons decreasing rate comparison processing, and advances the processing to step S68. In step S68, the CPU 101 determines whether instantaneous determination setting is effective. The instantaneous determination setting is a flag set to be effective in a case where it is instantaneously determined that there is a risk when it is determined that there is a risk according to the decreasing rate of the number of connected persons or the decreasing rate of the connection strength, and is set to either effective or ineffective. The instantaneous determination setting may be set to be effective or ineffective in advance, or may be set by the user who operates the PC 200. When the instantaneous determination setting is set to be effective, the CPU 101 advances the processing to step S69. Otherwise, the CPU 101 skips step S69 and advances the processing to step S70. In step S69, the CPU 101 executes number of persons decrease period comparison processing, and advances the processing to step S70.

In step S70, the CPU 101 executes connection strength decreasing rate comparison processing, and advances the processing to step S71. In step S71, the CPU 101 determines whether the instantaneous determination setting is effective. When the instantaneous determination setting is set to be effective, the CPU 101 advances the processing to step S72. Otherwise, the CPU 101 skips step S72, and advances the processing to step S73. In step S72, the CPU 101 executes strength decrease period comparison processing, and advances the processing to step S73.

In step S73, the CPU 101 executes number of connected persons deviation comparison processing, and advances the processing to step S74. In step S74, the CPU 101 executes connection strength deviation comparison processing, and advances the processing to step S75. In step S75, the CPU 101 determines whether there is an unselected customer company as the processing target in step S61. When there is the unselected customer company as the processing target, the CPU 101 returns the processing to step S61. When there is no unselected customer company, the CPU 101 returns the processing to the risk determination processing.

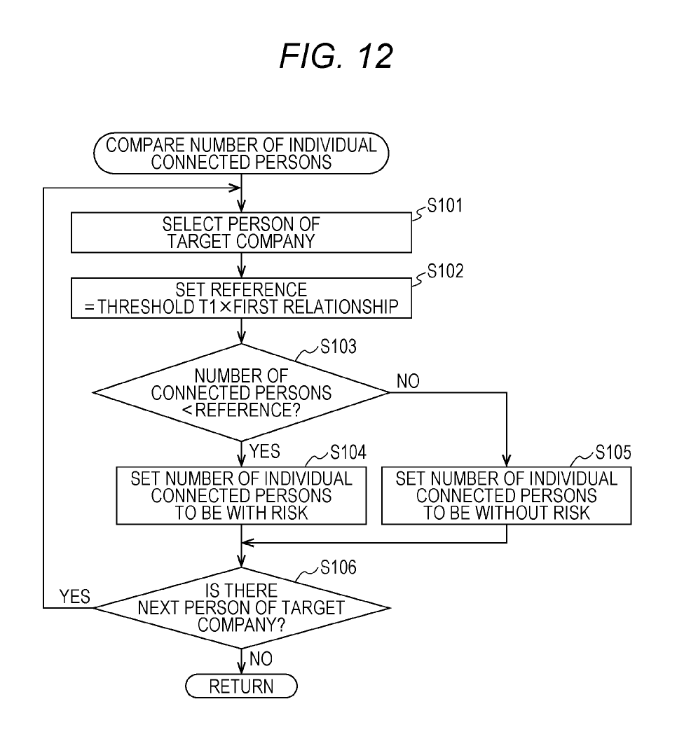

FIG. 12 is a flowchart illustrating an example of the number of individual connected persons comparison processing. The number of individual connected persons comparison processing is processing executed in step S63 of the comparison processing. The customer company for the target company has been selected, and the first relationship with the customer company has been decided and the second relation information has been further generated, before the number of individual connected persons comparison processing is executed.

Referring to FIG. 12, the CPU 101 selects the person belonging to the target company as a processing target (step S101). In next step S102, the CPU 101 sets the reference to be a value obtained by multiplying the threshold T1 by the first relationship with the customer company. The threshold T1 is a value obtained in advance as the threshold of the number of individual connected persons. In next step S103, the CPU 101 compares the number of connected persons for the customer company selected as the processing target with the reference, in the person selected in step S101. To be specific, the CPU 101 compares the number of connected persons included in the first connection information including the person identification information of the person selected in step S101 and the company identification information of the customer company selected as the processing target, with the reference set in step S102. When the number of connected persons is smaller than the reference, the CPU 101 advances the processing to step S104. Otherwise, the CPU 101 advances the processing to step S105. In step S104, the CPU 101 sets the number of individual connected persons to be with a risk, and advances the processing to step S106. To be specific, the CPU 101 stores risk information including the person identification information of the person selected in step S101, the company identification information of the customer company selected as the processing target, and the number of individual connected persons, to the HDD 104. In step S105, the CPU 101 sets the number of individual connected persons to be without a risk, and advances the processing to step S106. In step S106, the CPU 101 determines whether there is an unselected person as the processing target in step S101. When there is the unselected person as the processing target, the CPU 101 returns the processing to step S101. When there is no unselected person, the CPU 101 returns the processing to the comparison processing.

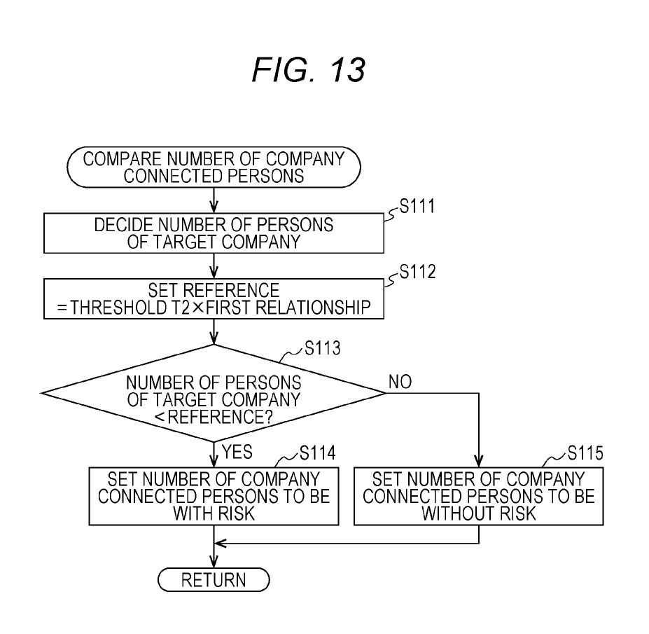

FIG. 13 is a flowchart illustrating an example of a flow of the number of company connected persons comparison processing. The number of company connected persons comparison processing is processing executed in step S64 of the comparison processing. The customer company for the target company has been selected, and the first relationship with the customer company has been decided and the second relation information has been further generated, before the number of individual connected persons comparison processing is executed.

Referring to FIG. 13, the CPU 101 decides the number of connected persons for the customer company selected as the processing target (step S111). To be specific, the CPU 101 decides a total of the numbers of connected persons respectively included in one or more pieces of the second connection information, each of the second connection information including the company identification information of the target company and the company identification information of the customer company selected as the processing target, to be the number of connected persons for the customer company. In next step S112, the CPU 101 sets the reference to be a value obtained by multiplying the threshold T2 by the first relationship. The threshold T2 is a value decided in advance as a threshold for the number of company connected persons. In next step S113, the CPU 101 compares the number of connected persons decided in step S111 with the reference. When the number of connected persons is smaller than the reference, the CPU 101 advances the processing to step S114. Otherwise, the CPU 101 advances the processing to step S115. In step S114, the CPU 101 sets the number of company connected persons to be with a risk, and returns the processing to the comparison processing. To be specific, the CPU 101 stores risk information including the company identification information of the customer company selected as the processing target and the number of company connected persons, to the HDD 104. In step S115, the CPU 101 sets the number of company connected persons to be without a risk, and returns the processing to the comparison processing.

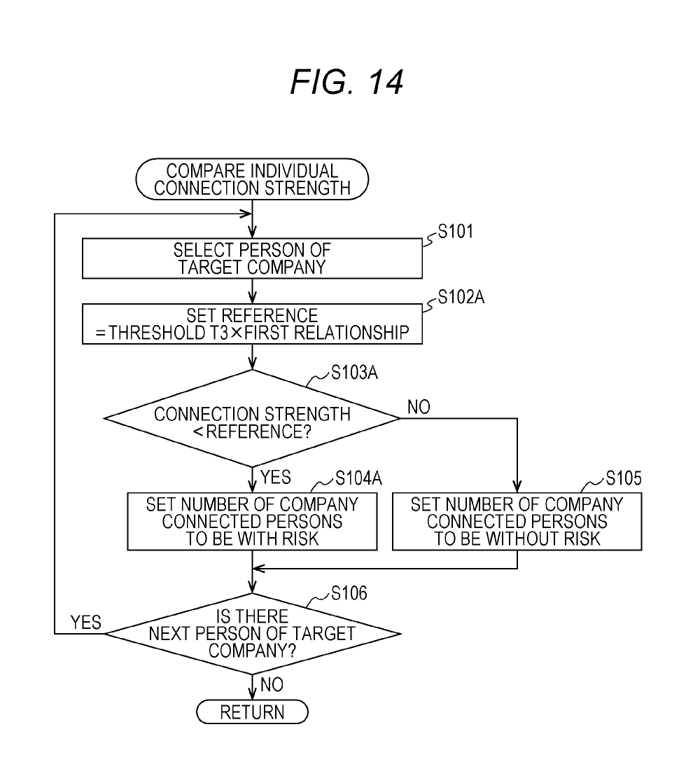

FIG. 14 is a flowchart illustrating an example of a flow of the individual connection strength comparison processing. The individual connection strength comparison processing is processing executed in step S65 of the comparison processing. The customer company for the target company has been selected, and the first relationship with the customer company has been decided and the second relation information has been further generated, before the individual connection strength comparison processing is executed. Referring to FIG. 14, a point different from the number of individual connected persons comparison processing illustrated in FIG. 12 is that steps S102 to S104 are respectively changed to steps S102A to S104A. Other processing is the same as the processing illustrated in FIG. 12, and thus description here is not repeated.

Referring to FIG. 14, in step S102A, the CPU 101 sets the reference to be a value obtained by multiplying the threshold T3 by the first relationship. The threshold T3 is a value decided in advance as the threshold of the individual connection strength. In next step S103A, the CPU 101 compares the connection strength to the customer company selected as the processing target with the reference, in the person selected in step S101. To be specific, the CPU 101 compares the connection strength included in the second connection information including the person identification information of the person selected in step S101 and the company identification information of the customer company selected as the processing target, with the reference set in step S102A. When the connection strength is smaller than the reference, the CPU 101 advances the processing to step S104A. Otherwise, the CPU 101 advances the processing to step S105. In step S104A, the CPU 101 sets the individual connection strength to be with a risk, and advances the processing to step S106. To be specific, the CPU 101 stores risk information including the person identification information of the person selected in step S101, the company identification information of the customer company selected as the processing target, and the individual connection strength, to the HDD 104.

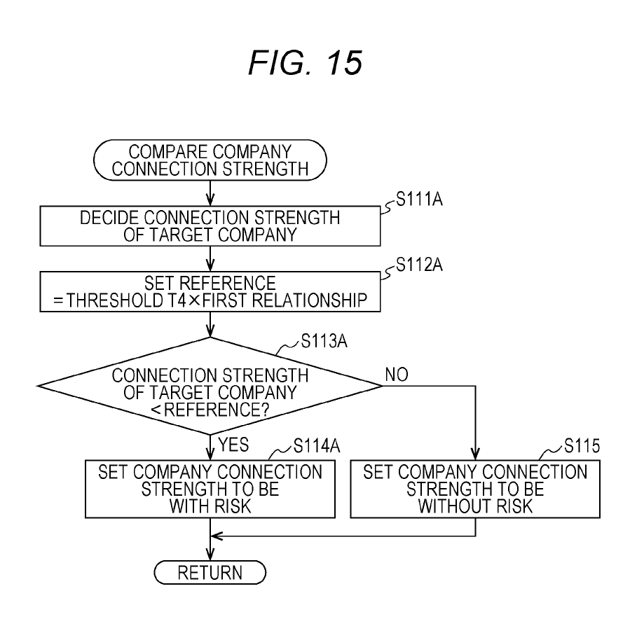

FIG. 15 is a flowchart illustrating an example of a flow of the company connection strength comparison processing. The company connection strength comparison processing is processing executed in step S66 of the comparison processing. The customer company for the target company has been selected, and the first relationship with the customer company has been decided and the second relation information has been further generated, before the company connection strength comparison processing is executed. Referring to FIG. 15, a different point from the number of company connected persons comparison processing illustrated in FIG. 13 is that steps S111 to S114 are respectively changed to steps S111A to S114A. Other processing is the same as the processing illustrated in FIG. 13, and thus description here is not repeated.

Referring to FIG. 15, the CPU 101 decides the connection strength to the customer company selected as the processing target (step S111A). To be specific, the CPU 101 decides a total of the connection strengths respectively included in one or more pieces of the second connection information, each of the second connection information including the company identification information of the target company and the company identification information of the customer company selected as the processing target, to be the connection strength to the customer company. In next step S112A, the CPU 101 sets the reference to be a value obtained by multiplying the threshold T4 by the first relationship. The threshold T4 is a value obtained in advance as the threshold of the company connection strength. In next step S113A, the CPU 101 compares the connection strength decided in step S111A with the reference. If the connection strength is smaller than the reference, the CPU 101 advances the processing to step S114A. Otherwise, the CPU 101 advances the processing to step S115. In step S114A, the CPU 101 sets the company connection strength to be with a risk, and returns the processing to the comparison processing. To be specific, the CPU 101 stores risk information including the company identification information of the customer company selected as the processing target and the company connection strength, to the HDD 104.

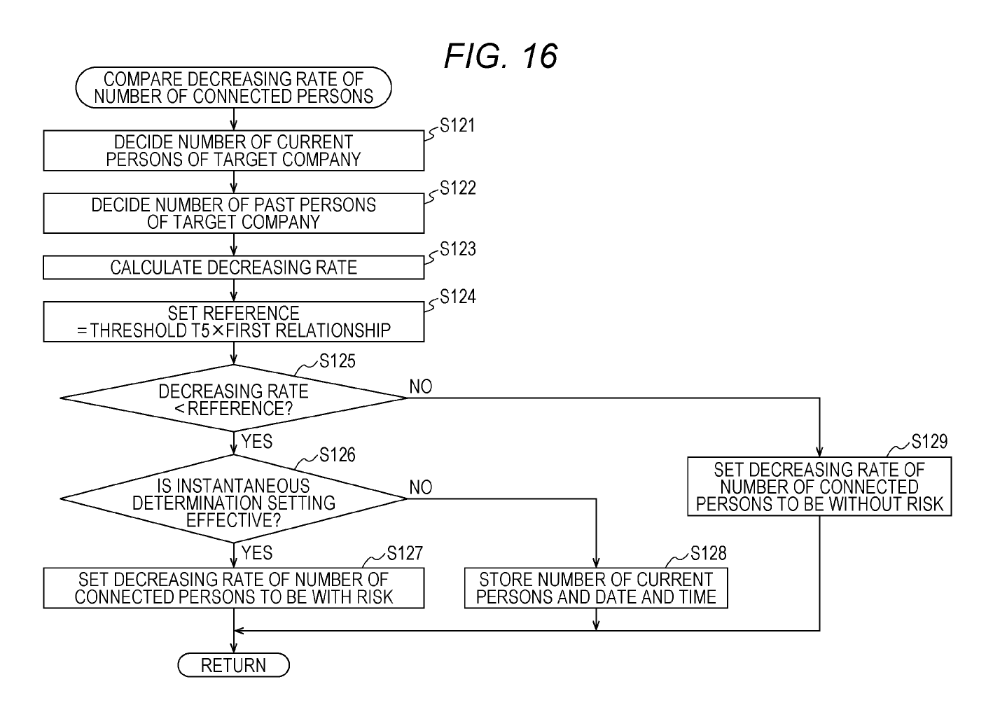

FIG. 16 is a flowchart illustrating an example of a flow of the number of connected persons decreasing rate comparison processing. The number of connected persons decreasing rate comparison processing is processing executed in step S67 of the comparison processing. The customer company for the target company has been selected, and the first relationship with the customer company has been decided and the second relation information has been further generated, before the number of connected persons decreasing rate comparison processing is executed.

Referring to FIG. 16, the CPU 101 decides the number of current persons of the target company (step S121). The CPU 101 decides the number of persons belonging to the target company and persons who are in contact with the person of the customer company selected as the processing target in the risk determination period. The CPU 101 extracts all the second relation information generated in the risk determination period, and including the company identification information of the target company and the company identification information of the customer company selected as the processing target, of the second relation information stored in the HDD 104, counts the personal identification information of the person of the target company included in the extracted second relation information, and decides a counted value to be the number of current persons of the target company.

In next step S122, the CPU 101 decides the number of past persons of the target company. The CPU 101 decides the number of persons belonging to the target company and persons who are in contact with the person of the customer company selected as the processing target in a period before the risk determination period. The CPU 101 extracts all the second relation information included in the history information including the date and time of a period before the risk determination period, of the history information stored in the HDD 104, and including the company identification information of the target company and the company identification information of the customer company selected as the processing target, counts the personal identification information of the person of the target company included in the extracted second relation information, and decides a counted value to be the number of past persons of the target company.

In next step S123, the CPU 101 calculates the decreasing rate. The CPU 101 decides a value obtained by dividing the number of current persons decided in step S121 by the number of past persons decided in step S122 to be the decreasing rate. In next step S124, the CPU 101 sets the reference to be a value obtained by multiplying the threshold T5 by the first relationship. The threshold T5 is a value obtained in advance as the threshold of the decreasing rate of the number of connected persons. In next step S125, the CPU 101 compares the decreasing rate calculated in step S123 with the reference. When the decreasing rate is smaller than the reference, the CPU 101 advances the processing to step S126. Otherwise, the CPU 101 advances the processing to step S128. In step S126, the CPU 101 determines whether the instantaneous determination setting is set to be effective. When the instantaneous determination setting is set to be effective, the CPU 101 advances the processing to step S127. Otherwise, the CPU 101 advances the processing to step S128. In step S127, the CPU 101 sets the decreasing rate of the number of connected persons to be with a risk, and returns the processing to the comparison processing. To be specific, the CPU 101 stores risk information including the company identification information of the customer company selected as the processing target and the decreasing rate of the number of connected persons, to the HDD 104. In step S128, the CPU 101 stores the number of current persons decided in step S121 and the current date and time to the HDD 104, and returns the processing to the comparison processing. In step S129, the CPU 101 sets the decreasing rate of the number of connected persons to be without a risk, and returns the processing to the comparison processing.

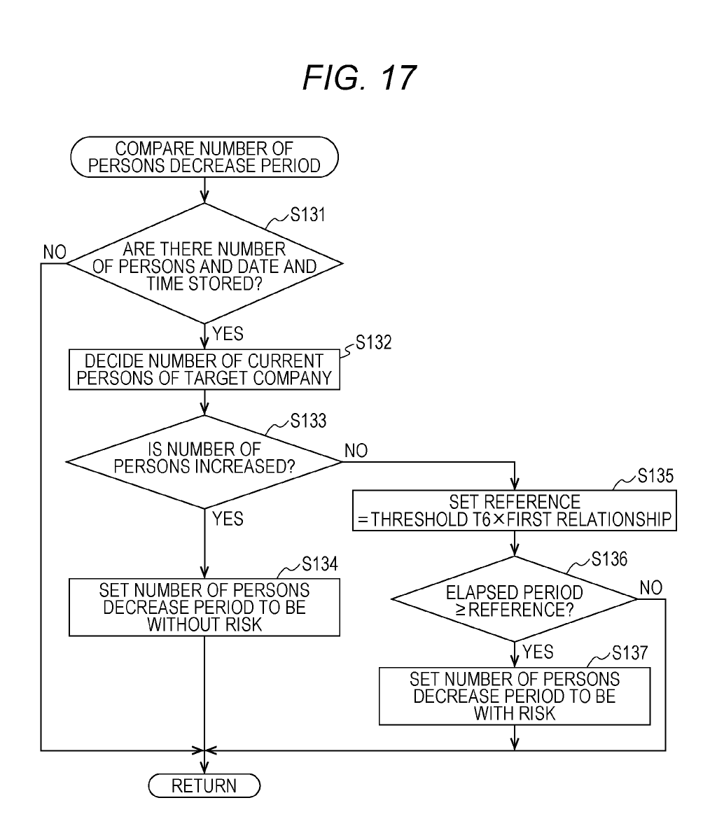

FIG. 17 is a flowchart illustrating an example of a flow of the number of persons decrease period comparison processing. The number of persons decrease period comparison processing is processing executed in step S69 of the comparison processing. The customer company for the target company has been selected, and the first relationship with the customer company has been decided and the second relation information has been further generated, before the number of persons decrease period comparison processing is executed. Further, in the number of connected persons decreasing rate comparison processing, there is a case in which the number of persons and the date and time are stored in the HDD 104.

Referring to FIG. 17, the CPU 101 determines whether the number of persons and the date and time are stored in the HDD 104. When the number of persons and the date and time are stored, the CPU 101 identifies the number of persons and the date and time, and advances the processing to step S132. Otherwise, the CPU 101 returns the processing to the comparison processing. In step S132, the CPU 101 decides the number of current persons of the target company. The CPU 101 decides the number of persons belonging to the target company and persons who are in contact with the person of the customer company selected as the processing target in the risk determination period.

In next step S133, the CPU 101 determines whether the number of persons has been increased. When the number of current persons decided in step S132 is larger than the number of past persons identified in step S131, the CPU 101 determines that the number of persons has been increased. When the number of persons has been increased, the CPU 101 advances the processing to step S134. Otherwise, the CPU 101 advances the processing to step S135. In step S134, the CPU 101 sets the number of persons decrease period to be without a risk, and returns the processing to the comparison processing.

In step S135, the CPU 101 sets the reference to be a value obtained by multiplying the threshold T6 by the first relationship. The threshold T6 is the value obtained in advance as the threshold of the number of persons decrease period. In next step S136, the CPU 101 compares an elapsed time from the past date and time identified in step S131 with the reference. When the elapsed time is the reference or more, the CPU 101 advances the processing to step S137. Otherwise, the CPU 101 returns the processing to the comparison processing. In step S137, the CPU 101 sets the number of persons decrease period to be with a risk, and returns the processing to the comparison processing. To be specific, the CPU 101 stores risk information including the company identification information of the customer company selected as the processing target, the number of current connected persons, and the elapsed period, to the HDD 104.

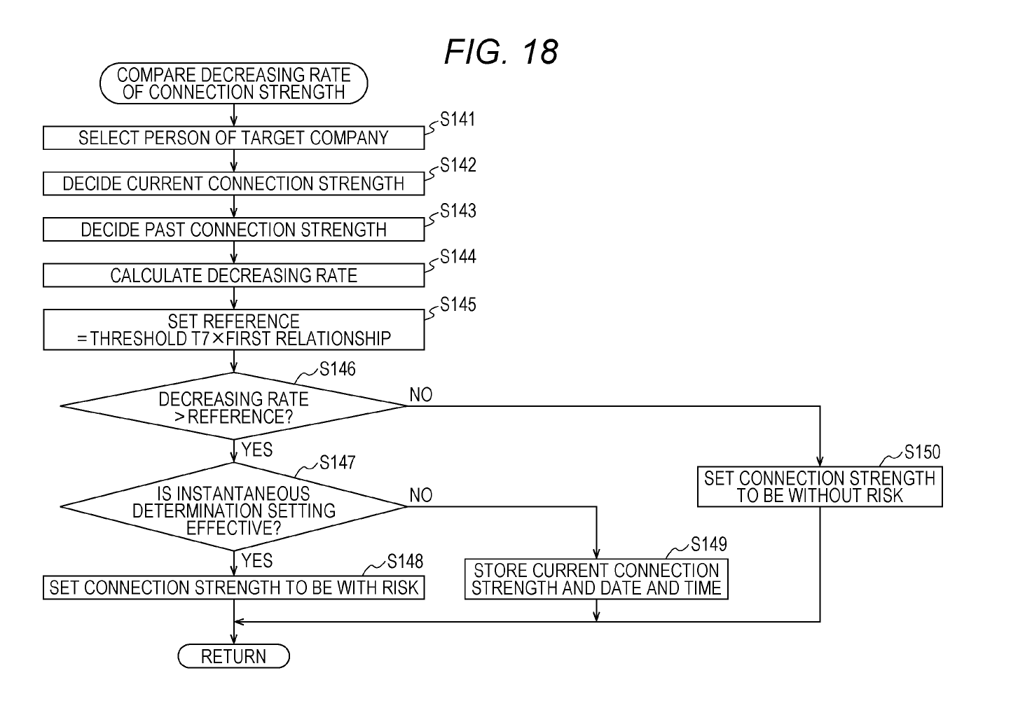

FIG. 18 is a flowchart illustrating an example of a flow of the connection strength decreasing rate comparison processing. The connection strength decreasing rate comparison processing is processing executed in step S70 of the comparison processing. The customer company for the target company has been selected, and the first relationship with the customer company has been decided and the second relation information has been further generated, before the connection strength decreasing rate comparison processing is executed.

Referring to FIG. 18, the CPU 101 selects the person belonging to the target company as a processing target (step S141). In next step S142, the CPU 101 decides the current connection strength (step S142). The CPU 101 decides the connection strength between the person selected in step S141 and the person who is in contact in the risk determination period. The CPU 101 extracts all the second relation information generated in the risk determination period, and including the person identification information of the person selected in step S141 and the company identification information of the customer company selected as the processing target, of the second relation information stored in the HDD 104, and decides a total of the connection strengths included in the extracted second relation information to be the current connection strength.

In next step S143, the CPU 101 decides the past connection strength. The CPU 101 decides the connection strength between the person selected in step S141 and the person who is in contact in the period before the risk determination period. The CPU 101 extracts all the second relation information included in the history information including the date and time of the period before the risk determination period, of the history information stored in the HDD 104, and including the person identification information of the person selected in step S141 and the company identification information of the customer company selected as the processing target, and decides a total of the connection strengths included in the extracted second relation information to be the past connection strength.

In next step S146, the CPU 101 calculates the decreasing rate. In step S142, the CPU 101 decides a value obtained by dividing the decided current connection strength by the past connection strength decided in step S142 to be the decreasing rate. In next step S145, the CPU 101 sets the reference to be a value obtained by multiplying the threshold T7 by the first relationship. The threshold T7 is a value decided in advance as the threshold of the decreasing rate of the connection strength. In next step S146, the CPU 101 compares the decreasing rate calculated in step S144 with the reference. If the decreasing rate is smaller than the reference, the CPU 101 advances the processing to step S147. Otherwise, the CPU 101 advances the processing to step S150. In step S147, the CPU 101 determines whether the instantaneous determination setting is set to be effective. When the instantaneous determination setting is set to be effective, the CPU 101 advances the processing to step S148. Otherwise, the CPU 101 advances the processing to step S149. In step S148, the CPU 101 sets the decreasing rate of the connection strength to be with a risk, and advances the processing to step S151. To be specific, the CPU 101 stores risk information including the company identification information of the customer company selected as the processing target and the decreasing rate of the connection strength, to be the HDD 104. In step S149, the CPU 101 stores the current connection strength decided in step S142, the current date and time, and the person identification information of the person selected in step S141, to the HDD 104, and advances the processing to step S149. In step S150, the CPU 101 sets the decreasing rate of the connection strength to be without a risk, and returns the processing to the comparison processing.

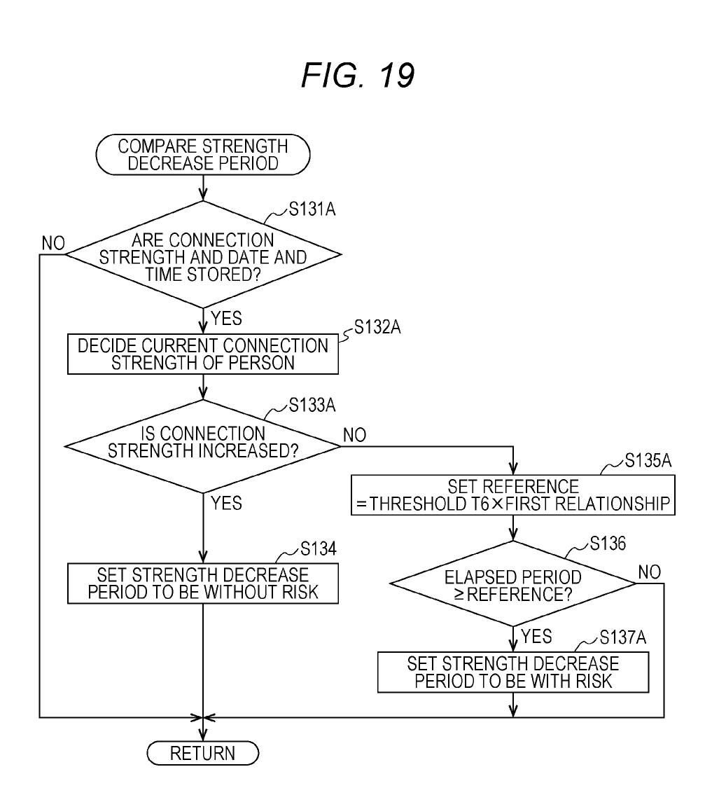

FIG. 19 is a flowchart illustrating an example of a flow of the strength decrease period comparison processing. The strength decrease period comparison processing is processing executed in step S72 of the comparison processing. The customer company for the target company has been selected, and the first relationship with the customer company has been decided and the second relation information has been further generated, before the strength decrease period comparison processing is executed. Further, in the connection strength decreasing rate comparison processing, there is a case in which the connection strength, the date and time, and the person identification information are stores in the HDD 104.

Referring to FIG. 19, a different point from FIG. 17 is that steps S131 to S133 and S137 are respectively changed to steps S131A to S133A and S137A. Other processing is the same as the processing illustrated in FIG. 17, and thus description here is not repeated.

Referring to FIG. 19, the CPU 101 determines whether the connection strength and the date and time are stored in the HDD 104 (step S131A). When the connection strength and the date and time are stored, the CPU 101 identifies the connection strength, the date and time, and the person identification information, and advances the processing to step S132A. Otherwise, the CPU 101 returns the processing to the comparison processing. In step S132A, the CPU 101 decides the connection strength of the person identified in step S131A to the customer company. The CPU 101 extracts all the second relation information generated in the risk determination period, and including the person identification information specified in step S131A and the company identification information of the customer company selected as the processing target, of the second relation information stored in the HDD 104, and decides a total of the connection strengths included in the extracted second relation information to be the current connection strength.

In next step S133A, the CPU 101 determines whether the connection strength has been increased. When the current connection strength decided in step S132A is larger than the past connection strength specified in step S131A, the CPU 101 determines that the connection strength has been increased. When the connection strength has been increased, the CPU 101 advances the processing to step S134. Otherwise, the CPU 101 advances the processing to step S135A. In step S134, the CPU 101 sets the number of persons decrease period to be without a risk, and returns the processing to the comparison processing. Note that the threshold T6 used in step S135A is a value obtained in advance as the threshold of the strength decrease period. In step S137A, the CPU 101 sets the strength decrease period to be with a risk, and returns the processing to the comparison processing. To be specific, the CPU 101 stores risk information including the person identification information specified in step S131A, the company identification information of the customer company selected as the processing target, the current connection strength, and the elapsed period, to the HDD 104.

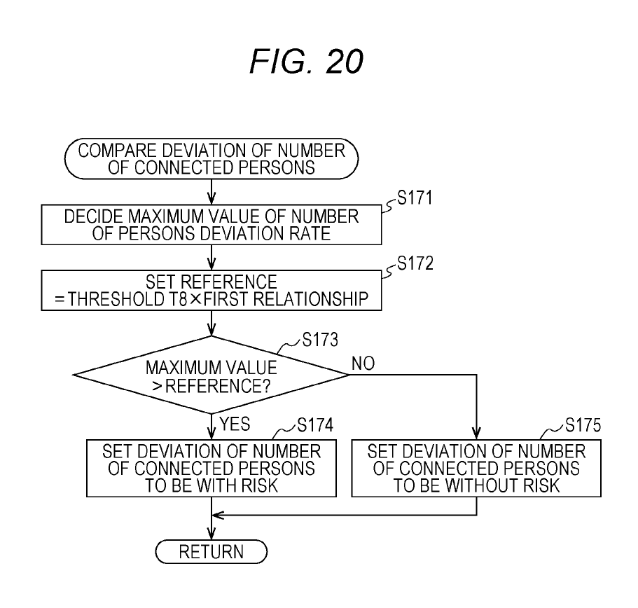

FIG. 20 is a flowchart illustrating an example of a flow of the number of connected persons deviation comparison processing. The number of connected persons deviation comparison processing is processing executed in step S73 of the comparison processing. The customer company for the target company has been selected, and the first relationship with the customer company has been decided and the second relation information has been further generated, before the number of connected persons deviation comparison processing is executed.

Referring to FIG. 20, the CPU 101 decides the maximum value of the number of persons deviation rates (step S171). The CPU 101 decides, for each of a plurality of persons belonging to the target company, the number of persons belonging to the customer company, who are in contact with the person in the risk determination period. The CPU 101 decides, for each of the plurality of persons belonging to the target company, the number of connected persons included in the second relation information generated in the risk determination period, and including the person identification information of the person, and the company identification information of the customer company selected as the processing target, of the second relation information stored in the HDD 104. The CPU 101 calculates a total of the numbers of the connected persons respectively decided for the plurality of persons belonging to the target company, and decides the number of persons deviation rates by dividing the numbers of connected persons respectively decided for the plurality of persons belonging to the target company by the total. Then, the CPU 101 decides the maximum value of the number of persons deviation rates respectively decided for the plurality of persons belonging to the target company.

In next step S172, the CPU 101 sets the reference to be a value obtained by multiplying the threshold T8 by the first relationship. The threshold T8 is a value decided in advance as the threshold of the deviation comparison of the number of connected persons. In next step S173, the CPU 101 compares the maximum value decided in step S171 with the reference. When the maximum value is larger than the reference, the CPU 101 advances the processing to step S174. Otherwise, the CPU 101 advances the processing to step S175. In step S174, the CPU 101 sets the number of connected persons deviation to be with a risk, and returns the processing to the comparison processing. To be specific, the CPU 101 stores risk information including the person identification information of the person having the maximum number of persons deviation rate, the company identification information of the customer company selected as the processing target, and the number of persons deviation rate, to the HDD 104. In step S175, the CPU 101 sets the number of connected persons deviation to be without a risk, and returns the processing to the comparison processing.

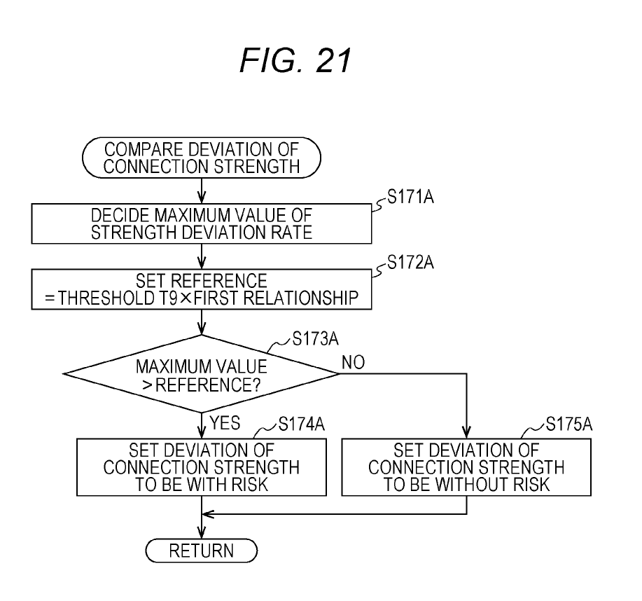

FIG. 21 is a flowchart illustrating an example of a flow of the connection strength deviation comparison processing. The connection strength deviation comparison processing is processing executed in step S74 of the comparison processing. The customer company for the target company has been selected, and the first relationship with the customer company has been decided and the second relation information has been further generated, before the connection strength deviation comparison processing is executed.

Referring to FIG. 21, the CPU 101 decides the maximum value of the strength deviation rates (step S171A). The CPU 101 decides, for each of the plurality of persons belonging to the target company, the connection strength between the person, and the person belonging to the customer company, who is in contact with the person of the target company in the risk determination period. The CPU 101 decides, for each of the plurality of persons belonging to the target company, the connection strength included in the second relation information generated in the risk determination period, and including the person identification information of the person and the company identification information of the customer company selected as the processing target, of the second relation information stored in the HDD 104. The CPU 101 calculates a total of the connection strengths respectively decided for the plurality of persons belonging to the target company, and decides the strength deviation rates by dividing the connection strengths respectively decided for the plurality of persons belonging to the target company by the total. Then, the CPU 101 decides the maximum value of the strength deviation rates respectively decided for the plurality of persons belonging to the target company.

In next step S172A, the CPU 101 sets the reference to be a value obtained by multiplying the threshold T9 by the first relationship. The threshold T9 is a value decided in advance as the threshold of the connection strength deviation comparison. In next step S173A, the CPU 101 compares the maximum value decided in step S171A with the reference. When the maximum value is larger than the reference, the CPU 101 advances the processing to step S174A. Otherwise, the CPU 101 advances the processing to step S175A. In step S174A, the CPU 101 sets the connection strength deviation to be with a risk, and returns the processing to the comparison processing. To be specific, the CPU 101 stores risk information including the person identification information of the person having the maximum strength deviation rate, the company identification information of the customer company selected as the processing target, and the strength deviation rate in the HDD 104. In step S175A, the CPU 101 sets the connection strength deviation to be without a risk, and returns the processing to the comparison processing.

### EXAMPLES

Next, a specific example of determining risks of the target company A for the respective customer companies B1 and B2 in a case where the target company A transacts business with the two customer companies B1 and B2 will be described.

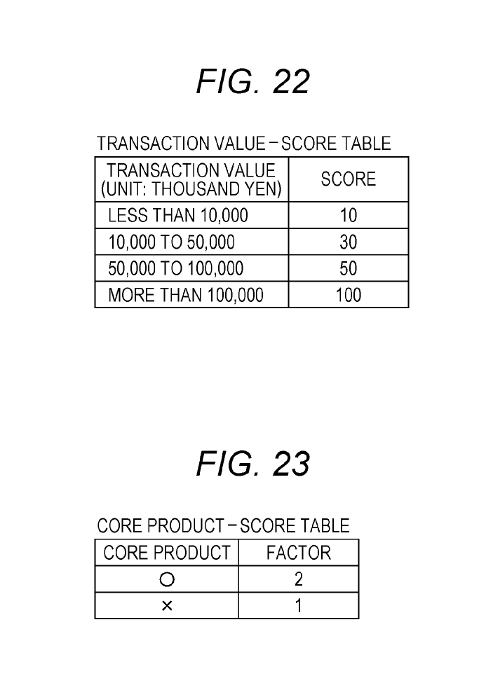

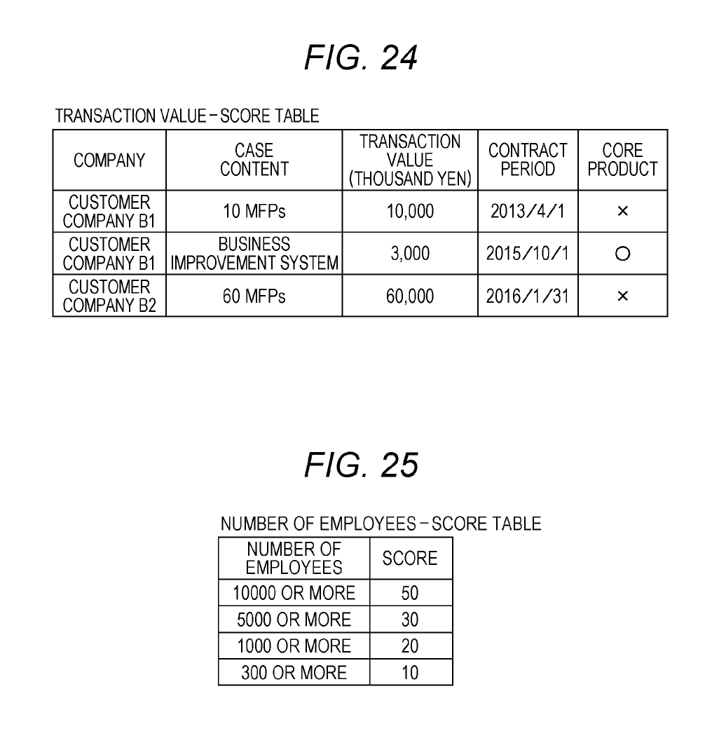

First, the first relationship of the target company A with the customer company B1 and the first relationship of the target company A with the customer company B2 are obtained. FIG. 22 is a diagram illustrating an example of a table for deciding the score for the transaction value. FIG. 23 is a diagram illustrating an example of a table for deciding the factor for existence or non-existence of the core product. FIG. 24 is a diagram illustrating an example of the company transaction information. Referring to FIG. 24, three transaction cases are illustrated as the company transaction information. The first transaction case indicates that 10 non-core product MFPs are sold at 10, 000 thousand yen on Apr. 1, 2013, to the customer company B1. The second transaction case indicates that a core product business improvement system is sold at 3, 000 thousand yen on Oct. 1, 2015, to the customer company B1. The third transaction case indicates that 60 non-core product MFPs at sold at 610, 000 thousand yen on Jan. 31, 2016, to the customer company B2.

The transaction item score of the customer company B1 is calculated on the basis of the first transaction case and the second transaction case. The transaction value 10,000 (thousand yen) of the first transaction case is converted into the score “30”, and the factor “1.0” is decided because the product is not the core product. The transaction value 3,000 (thousand yen) of the second transaction case is converted into the score “10”, and the factor “2.0” is decided because the product is the core product. Therefore, the transaction item score of the customer company B1 becomes a sum “50” of a value “30” obtained by multiplying the score “30” of the first case by the factor “1.0” and a value “20” obtained by multiplying the score “10” of the first case by the factor “2.0”.

The transaction item score of the customer company B2 will be calculated on the basis of the third transaction case. The transaction value 60,000 (thousand yen) of the third transaction case is converted into the score “50”, and the factor “1.0” is decided because the product is not the core product. Therefore, the transaction item score of the customer company B2 becomes a value “50” obtained by multiplying the score “50” of the third case by the factor “1.0”.

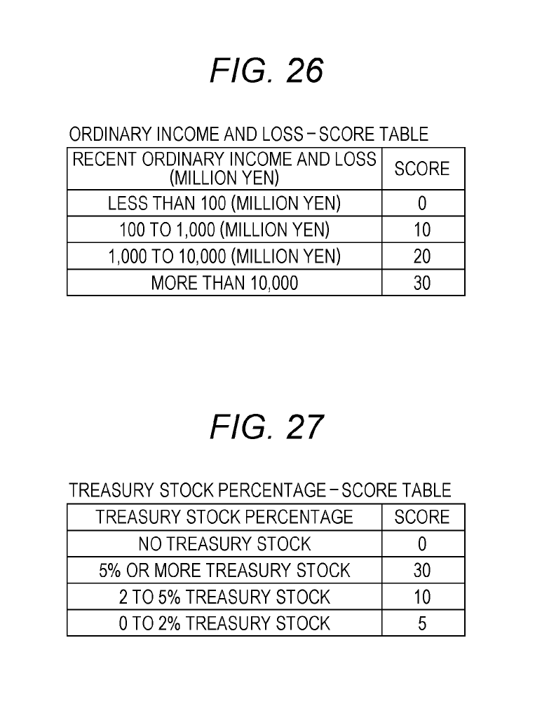

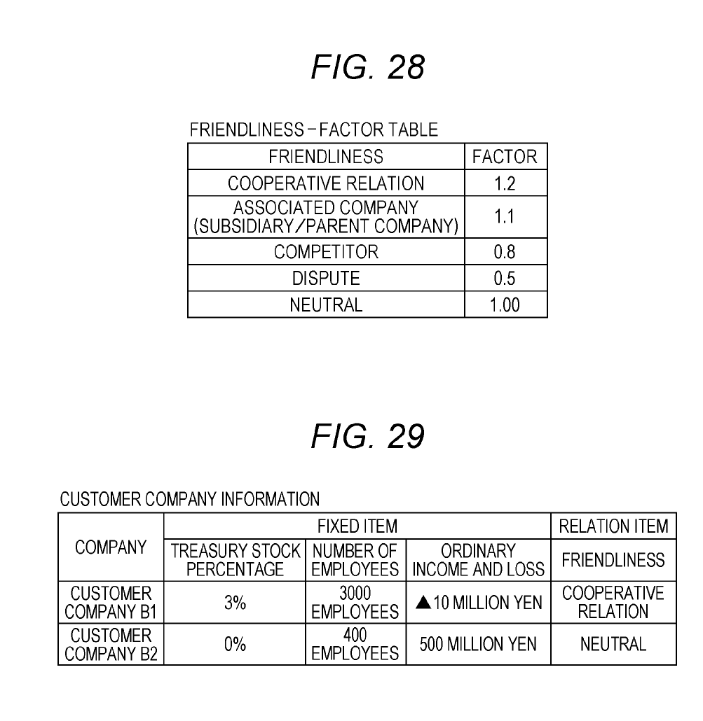

FIG. 25 is a diagram illustrating an example of a table for deciding the score for the number of employees. FIG. 26 is a diagram illustrating an example of a table for deciding the score for the ordinary income and loss. FIG. 27 is a diagram illustrating an example of a table for deciding the score for the treasury stock percentage. FIG. 28 is a diagram illustrating an example of a table for deciding the factor for the friendliness. FIG. 29 is a diagram illustrating an example of the customer company information. Referring to FIG. 29, the customer company B1 has the treasury stock percentage of 3%, the number of employees of 3000, the ordinary income of minus 10 million yen, and a cooperative relation with the target company A. Further, the customer company B2 has the treasury stock percentage of 0%, the number of employees of 400, the ordinary income of 500 million yen, and a neutral relation with the target company A.

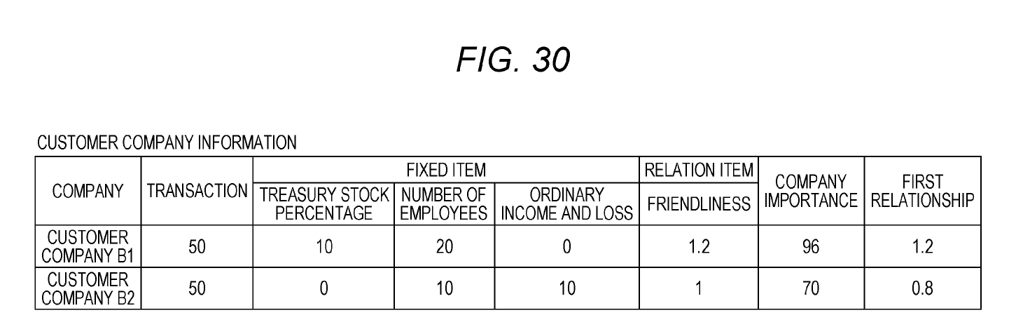

FIG. 30 is a diagram illustrating the score, the factor, and the company importance of the plurality of items of the customer companies. Referring to FIG. 30, the transaction item scores become “50” in the respective customer companies B1 and B2, as described above.

The treasury stock percentage “3%” of the customer company B1 is converted into the score “10”, and the treasury stock percentage “0%” of the customer company B2 is converted into the score “0”. The number of employees “3000” of the customer company B1 is converted into the score “20”, and the number of employees “400” of the customer company B2 is converted into the score “10”. The ordinary income and loss “−10 million yen” of the customer company B1 is converted into the score “0”, and the ordinary income and loss “500 million yen” of the customer company B2 is converted into the score “10”. The friendliness “cooperative relation” of the customer company B1 is converted into the factor “1.2”, and the friendliness “neutral” of the customer company B2 is converted into the factor “1.0”.

The company importance of the customer company B1 becomes a value (96) obtained by multiplying a sum of the scores (50, 10, 20, 0) of the plurality of items by the factor (1.2) of the friendliness. The company importance of the customer company B2 becomes a value (70) obtained by multiplying a sum of the scores (50, 0, 10, 10) of the plurality of items by the factor (1.0) of the friendliness.

The first relationship of the customer company B1 becomes a value (1.2) obtained by dividing the company importance (96) of the customer company B1 by an average (83) of the company importances. The first relationship of the customer company B2 becomes a value (0.8) obtained by dividing the company importance (70) of the customer company B2 by the average (83) of the company importances.

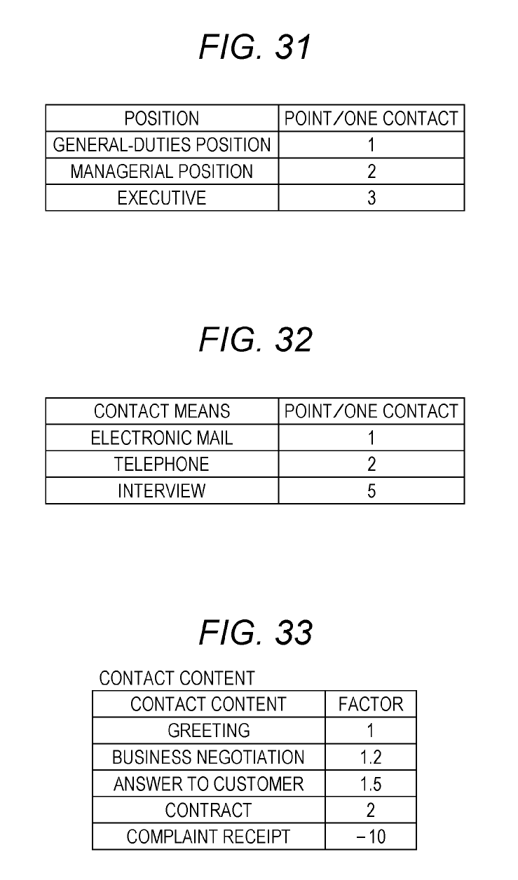

FIG. 31 is a diagram illustrating an example of a table for deciding the score for the position. FIG. 32 is a diagram illustrating an example of a table for deciding the score for the contact means. FIG. 33 is a diagram illustrating an example of a table for deciding the factor for the contact content.

For example, when a person P1 of the target company A has a meeting regarding a negotiation in an interview with a person P2 who is an executive of the customer company B1, a value (9.6) obtained by multiplying a sum (8) of the point (3) for the executive and the point (5) for the interview by the factor (1.2) for the negotiation is a part of the connection strength of the person P1 for the customer company B1. When the person P1 comes in contact with a person in the customer company B1 a plurality of times, a total of points, the point being provided to each contact, becomes the connection strength.

Further, when the person P1 of the target company A greets a person P3 in a managerial position of the customer company B1 with an electronic mail, a value (3) obtained by multiplying a sum (3) of the point (2) for the managerial position and the point (1) for the electronic mail by the factor (1) for the greeting is a part of the connection strength of the person P1 for the customer company B1.

Further, when the person P1 of the target company A receives complaint from a person P4 in a general-duties position of the customer company B1 with an electronic mail, a value (−20) obtained by multiplying a sum (2) of the point (1) for the general-duties position and the point (1) for the electronic mail by the factor (−10) for the complaint reception is a part of the connection strength of the person P1 for the customer company B1. Note that, in the case of the complaint reception, the contact means may not be considered. Further, when a replay to the electronic mail from the general-duties position of the customer company B1 is delayed, a minus point, which becomes small according to the number of delayed days, may be added to the connection strength.

<Risk Determination of Each Individual Person by Number of Connected Persons>

Assume that the threshold T1 decided in advance to determine the risk of each individual person in the number of connected persons is 10 persons. In this case, the reference T1B1 for the customer company B1 becomes a value (12 persons) obtained by multiplying the threshold T1 (10 persons) by the first relationship G1 (1.2) of the customer company B1, and the reference T1B2 for the customer company B2 becomes a value (8 persons) obtained by multiplying the threshold T1 (10 persons) by the first relationship G1 (0.8) of the customer company B2. Therefore, the risk of the person P1 of the target company is decided when the number of persons who are in contact with the person belonging to the customer company B1 in the risk determination period goes below 12 persons. The risk of the person P1 of the target company is determined when the number of persons who are in contact with the person belonging to the customer company B2 in the risk determination period goes below 8 persons.

<Risk Determination by Number of Persons of Target Company>

Assume that the threshold T2 decided in advance to determine the risk by the number of persons of the target company is ten. In this case, the reference T2B1 for the customer company B1 becomes a value (12 persons) obtained by multiplying the threshold T2 (10 persons) by the first relationship G1 (1.2) of the customer company B1, and the reference T2B2 for the customer company B2 becomes a value (8 persons) obtained by multiplying the threshold T2 (10 persons) by the first relationship G1 (0.8) of the customer company B2. Therefore, the risk is determined when the number of persons of the target company, who are in contact with the customer company B1 in the risk determination period, goes below 12 persons, and the risk is determined when the number of persons of the target company, who are in contact with the customer company B2 in the risk determination period, goes below 8 persons.

<Risk Determination of Each Individual Person by Connection Strength>

Assume that the threshold T3 to determine the risk of each individual person by the connection strength is 50 points. In this case, the reference T3B1 for the customer company B1 becomes a value (60 points) obtained by multiplying the threshold T3 (50 points) by the first relationship G1 (1.2) of the customer company B1, and the reference T3B2 for the customer company B2 becomes a value (48 points) obtained by multiplying the threshold T3 (60 points) by the first relationship G1 (0.8) of the customer company B2. Therefore, the risk is determined when the total of the connection strengths of the person P1 of the target company, who is in contact with the person belonging to the customer company B1 in the risk determination period, goes below 60 points, and the risk is determined when the total of the connection strengths of the person P1 of the target company, who is in contact with the person belonging to the customer company B2 in the risk determination period, goes below 48 points.

<Risk Determination of Target Company by Connection Strength>

Assume that the threshold T4 to determine the risk of the target company by the connection strength is 200 points. In this case, the reference T4B1 for the customer company B1 becomes a value (240 points) obtained by multiplying the threshold T4 (200 points) by the first relationship G1 (1.2) of the customer company B1, and the reference T4B2 for the customer company B2 becomes a value (160 points) obtained by multiplying the threshold T4 (200 points) by the first relationship G1 (0.8) of the customer company B2. Therefore, the risk is determined when the total of the connection strengths of the respective persons of the target company, who are in contact with the person belonging to the customer company B1 in the risk determination period, goes below the 240 points, and the risk is determined when the total of the connection strengths of the respective persons of the target company, who are in contact with the person belonging to the customer company B2 in the risk determination period, goes below 160 points.

<Risk Determination by Decreasing Rate of Number of Connected Persons>

Assume that the threshold T5 to determine the risk by the decreasing rate of the number of connected persons is 30%. In this case, the reference T5B1 for the customer company B1 becomes a value (24%), which is obtained by subtracting 1 from the first relationship G1 (1.2) of the customer company B1, multiplying the threshold T5 (30%) by the subtracted value, and subtracting the multiplied value from the threshold T5 (30%), according to the formula (1). The reference T4B2 for the customer company B2 becomes a value (36%), which is obtained by subtracting 1 from the first relationship G1 (0.8) of the customer company B2, multiplying the threshold T5 (30%) by the subtracted value, and subtracting the multiplied value from the threshold T5 (30%), according to the formula (1). Therefore, the risk is determined when the decreasing rate of the number of persons of the target company, who are in contact with the customer company B1 in the risk determination period, exceeds 24%, and the risk is determined when the decreasing rate of the number of persons of the target company, who are in contact with the customer company B2 in the risk determination period, exceeds 36%.

<Risk Determination by Duration of Decrease in Number of Connected Persons>

Assume the threshold T6 to determine the risk by the duration of a decrease in the number of connected persons is 90 days. In this case, the reference T6B1 for the customer company B1 becomes a value (72 days), which is obtained by subtracting 1 from the first relationship G1 (1.2) of the customer company B1, multiplying the threshold T6 (90 days) by the subtracted value, and subtracting the multiplied value from the threshold T6 (90 days), according to the formula (1). The reference T6B2 for the customer company B2 becomes a value (108 days), which is obtained by subtracting 1 from the first relationship G1 (0.8) of the customer company B2, multiplying the threshold T6 (90 days) by the subtracted value, and subtracting the multiplied value from the threshold T6 (90 days), according to the formula (1). Therefore, the risk is determined when the number of persons is not increased even if 90 days pass after the decreasing rate of the number of persons of the target company, who are in contact with the customer company B1 in the risk determination period, exceeds 24%, and the risk is determined when 108 days pass after the decreasing rate of the number of persons of the target company, who are in contact with the customer company B2 in the risk determination period, exceeds 36%.

<Risk Determination by Decreasing Rate of Connection Strength>

Assume that the threshold T7 to determine the risk by the decreasing rate of the connection strength is 30%. In this case, the reference T7B1 for the customer company B1 becomes a value (240), which is obtained by subtracting 1 from the first relationship G1 (1.2) of the customer company B1, multiplying the threshold T7 (30%) by the subtracted value, and subtracting the multiplied value from the threshold T7 (30%), according to the formula (1). The reference T7B2 for the customer company B2 becomes a value (360), which is obtained by subtracting 1 from the first relationship G1 (0.8) of the customer company B2, multiplying the threshold T7 (30%) by the subtracted value, and subtracting the multiplied value from the threshold T7 (30%), according to the formula (1). Therefore, the risk is determined when the decreasing rate of the connection strength of the person of the target company, who is in contact with the customer company B1 in the risk determination period, exceeds 24%, and the risk is determined when the decreasing rate of the connection strength of the person of the target company, who is in contact with the customer company B2 in the risk determination period, exceeds 36%.

<Risk Determination by Deviation of Number of Connected Persons>

Assume the threshold T8 to determine the risk by the deviation of the number of connected persons is 50%. In this case, the reference T8B1 for the customer company B1 becomes a value (40%), which is obtained by subtracting 1 from the first relationship G1 (1.2) of the customer company B1, multiplying the threshold T8 (50%) by the subtracted value, and subtracting the multiplied value from the threshold T8 (50%), according to the formula (1). The reference T8B2 for the customer company B2 becomes a value (600), which is obtained by subtracting 1 from the first relationship G1 (0.8) of the customer company B2, multiplying the threshold T8 (50%) by the subtracted value, and subtracting the multiplied value from the threshold T8 (50%), according to the formula (1). Therefore, the risk is determined when the number of persons deviation rate in the target company to the customer company B1 in the risk determination period exceeds 40%, and the risk is determined when the number of persons deviation rate to the customer company B2 in the risk determination period exceeds 60%.

<Risk Determination by Deviation of Connection Strength>

Assume that the threshold T9 to determine the risk by the deviation of the connection strength is 50%. In this case, the reference T9B1 for the customer company B1 becomes a value (40%), which is obtained by subtracting 1 from the first relationship G1 (1.2) of the customer company B1, multiplying the threshold T9 (50%) by the subtracted value, and subtracting the multiplied value from the threshold T9 (50%), according to the formula (1). The reference T9B2 for the customer company B2 becomes a value (60%), which is obtained by subtracting 1 from the first relationship G1 (0.8) of the customer company B2, multiplying the threshold T9 (50%) by the subtracted value, and subtracting the multiplied value from the threshold T9 (50%), according to the formula (1). Therefore, the risk is determined when the strength deviation rate in the target company to the customer company B1 in the risk determination period exceeds 40%, and the risk is determined when the strength deviation rate to the customer company B2 in the risk determination period exceeds 60%.

As described above, the risk determination device 100 in the present embodiment decides the first relationships that indicate the relative relations between the target company A and the respective customer companies B1 and B2, decides the second relationships that indicate the degrees of connection of the person belonging to the target company A, for the respective customer companies B1 and B2, and determines the risks in the target company A to the customer companies B1 and B2 on the basis of the first relationships and the second relationships. Therefore, the risks between the target company A and the respective customer companies B1 and B2 can be determined from the activity of the person belonging to the target company A.

Further, the risk determination device 100 compares the degree of connection of the individual person belonging to the target company A with the customer company B1, with the reference decided by the relative relation between the target company A and the customer company B1, and compares the degree of connection of the individual person belonging to the target company A with the customer company B2, with the reference decided by the relative relation between the target company A and the customer company B2. Therefore, in the target company A, the references are different between the customer company B1 and the customer company B2, and thus the risks can be determined with the references respectively suitable for the customer company B1 and the customer company B2. Therefore, the scale of the company serving as the target of the risk determination is not limited, and can support the risk determination of any company.

Further, the risk determination device 100 decides the first relationship on the basis of the relative relation between the customer company B1 and the customer company B2, and thus can decide the first relationship suitable for the customer company B1 and the customer company B2 that are related to the target company A.

Further, the risk determination device 100 determines the risk on the basis of the temporal change of the second relationship, and thus can predict the risk from the tendency of the degree of connection.

Further, the risk determination device 100 determines the risk by the deviation of the degrees of connection of the plurality of persons belonging to the target company A, for the customer company B1, and thus can determine concentration of the degrees of connection of persons to be the risk.

Further, the risk determination device 100 determines the risk to the customer company B1, for each of the plurality of persons belonging to the target company A, and thus can determine the risk for each person.

Note that the present embodiment has been described using the risk determination device 100 as an example. However, it goes without saying that the invention can be grasped as a risk determination method for executing the risk determination processing illustrated in FIGS. 7 to 21, and a risk determination program for causing the CPU 101 included in the risk determination device 100 to execute the risk determination method.

<Supplementary Note>

(1) The risk determination system according to Item. 3, wherein

the intergroup relationship decision unit decides relative values indicating the relative relations with the first group being respectively corresponding to the plurality of groups, and decides the first relationship as a value indicating a position of the relative value to the second group in the plurality of decided relative values.

(2) The risk determination system according to Item. 1 or 2, wherein

the intergroup relationship decision unit decides the first relationships for a plurality of respective groups including the second group, and

the first relationship decided for the second group indicates relative relations between the second group and one or more respective groups other than the second group, of the plurality of groups.

Although the present invention has been described and illustrated in detail, it is clearly understood that the same is by way of illustrated and example only and is not to be taken by way of limitation, the scope of the present invention being interpreted by terms of the appended claims. The scope of the present invention is intended to include all changes within the scope of the claims, meanings of equivalents, and the scope of the equivalents.

What is claimed is:

1. A risk determination system comprising:
an intergroup relationship decision unit configured to decide a first relationship indicating a relative relation between a first group and a second group;
an interperson relationship decision unit configured to decide a second relationship indicating a degree of connection of a person belonging to the first group to the second group; and
a determination unit configured to determine a risk in the first group to the second group on the basis of the first relationship and the second relationship.

2. The risk determination system according to claim 1, wherein
the determination unit compares the second relationship with a reference decided on the basis of the first relationship.

3. The risk determination system according to claim 1, wherein
the intergroup relationship decision unit decides the first relationship on the basis of relative relations between the second group and one or more respective groups other than the second group, of a plurality of groups including the second group.

4. The risk determination system according to claim 1, wherein
the determination unit determines the risk on the basis of temporal change of the second relationship.

5. The risk determination system according to claim 1, wherein,
when there is a plurality of the persons belonging to the first group, the determination unit determines the risk on the basis of deviation of the second relationships respectively corresponding to the plurality of persons.

6. The risk determination system according to claim 1, wherein,
when there is a plurality of the persons belonging to the first group, the determination unit determines the risks of the plurality of the persons to the second group on the basis of the first relationship and the second relationships respectively corresponding to the plurality of persons.

7. A risk determination method comprising the steps of:
deciding a first relationship indicating a relative relation between a first group and a second group;
deciding a second relationship indicating a degree of connection of a person who belongs the first group to the second group; and
determining a risk in the first group to the second group on the basis of the first relationship and the second relationship.

8. A non-transitory recording medium storing a computer readable risk determination program for causing a computer to execute the steps of:
deciding a first relationship indicating a relative relation between a first group and a second group;
deciding a second relationship indicating a degree of connection of a person who belongs the first group to the second group; and
determining a risk in the first group to the second group on the basis of the first relationship and the second relationship.
